(19) United States
(12) Patent Application Publication
(10) Pub. No.: US 2018/0223137 A1
(43) Pub. Date: Aug. 9, 2018

(54) WATER-RESISTANT ADHESIVE MASS FOR BONDING ON WET SURFACES, IN PARTICULAR FOR USES WITH AUTOMOBILES

(71) Applicant: TESA SE, Norderstedt (DE)

(72) Inventors: Philipp PREUSS, Hamburg (DE); Kai ELLRINGMANN, Hamburg (DE)

(73) Assignee: TESA SE, Norderstedt (DE)

(21) Appl. No.: 15/320,419

(22) PCT Filed: Aug. 17, 2015
(86) PCT No.: PCT/EP2015/068808

§ 371 Date: Dec. 20, 2016

(30) Foreign Application Priority Data
Aug. 28, 2014 (DE) 10 2014 217 193.8

(51) Int. Cl. C09J 133/06; C09J 133/08

(52) U.S. Cl. CPC C09J 133/064; C09J 2201/606; C09J 133/08

(57) ABSTRACT

Method for bonding to high polarity surfaces with a pressure sensitive adhesive (PSA) K, being the product of crosslinking a polymer material comprising:
(A) at least one polymer component A comprising:
   (i) 60 wt % to 80 wt % of component A1 comprising:
      (i-a) 1 wt % to 15 wt % of at least one monomer a comprising compounds having at least one ethylenically unsaturated bond, and
      (i-b) 85 wt % to 99 wt % of at least one monomer b selected from the group consisting of acrylic esters and/or methacrylic esters,
   (ii) 20 wt % to 40 wt % of at least one resin component A2, and
(B) at least one crosslinker component B comprising covalently crosslinking di- or polyfunctional compounds;
the high polarity surfaces comprising
(I) at least one hydroxyl, carbonyl, carboxyl, SH or NH group and/or at least one ionic group, and/or
(II) at least one adsorbed migratable compound containing at least one hydroxyl group.

The invention relates to the use of a pressure sensitive adhesive (PSA) comprising acrylic polymers and ethylenically unsaturated compounds having at least one carboxylic acid group and also to sheetlike bonding means comprising this PSA for the bonding of articles to highly polar surfaces. Articles are, in particular, laser-writable and anti-counterfeit films. Highly polar surfaces comprise adsorbed migratable compounds comprising at least one hydroxyl group. These surfaces are, for example, at least partly wetted, moist or wet surfaces.

DE 81 30 861 U1 discloses laser-writable labels having an outer and, disposed below it, a second varnish layer, the varnish layer being produced from polyurethane acrylate and hexanediol bisacrylate. No adverse effects on the material are observed as a result of 500 hours of Weatherometer influence. Building on this, DE 100 48 665 A1 discloses laser-writable labels having an electron beam-cured varnish layer. A method for producing laser-writable labels of this kind is described in DE 101 42 638 A1, in which an engraving layer with a UV-curable varnish is incorporated. By means of an additional compensation layer, DE 10 2005 061 125 A1 produces labels which rebuff adverse effects from high temperatures above 140° C. As a result, cracks in the acrylate adhesive and hence adverse effects on the bonding to the substrate are prevented. Nevertheless, nothing is said about the water resistance of such laser-writable films and/or labels, nor about how the adhesive affects the water resistance of the products.

The problem of water resistance arises from practice, where it is not possible to ensure sufficient bonding to surfaces which are wet, moist, or have been partly wetted with a film of liquid. Frequently, moreover, compounds containing hydroxyl groups penetrate over the course of time, as a result of external influences, and adversely affect the bonding.

EP 2 179 858 A1 discloses a heat-resistant, fragile label having a varnish layer, in which water resistance is described for the glycol polymer present. For the varnish layer, acrylic polymers (made from acrylic and methacrylic monomers) with functional groups such as carboxyl and OH groups are disclosed, producing a heightened hydrophilicity. No further details are disclosed of any potential water resistance on the part of the products.

It is an object of the present invention, therefore, to provide a pressure sensitive adhesive (PSA) which exhibits high water resistance (on storage in water, for example). A further object of the present invention is to provide a PSA composition for adhesive layers in laser-writable articles, especially labels, films or diecuts. The intention, furthermore, is to provide this water-resistant, laser-writable article and also the corresponding method for producing it. An object of the present invention, furthermore, is to provide a PSA, in particular a sheetlike bonding means, and a water-resistant, laser-writable article both of which exhibit permanent adhesion to and on the substrate, especially on removal of water. Another object is to improve sufficient bonding of articles, especially the aforementioned articles, on highly polar surfaces such as surfaces wetted at least partly with hydroxyl-containing compounds such as with aqueous solutions, and at the same time to retain at least or to improve the technical requirements made of the laser-writable articles. The requirements made of the material in such articles that is intended to be written on include the requirements that it shall be rapidly writable, offers high spatial resolution capacity, is extremely easy to use, and that the decomposition products shall not be corrosive. A particular object of the present invention is to provide an article which is highly suitable for the method of laser ablation, without restrictions on the other aforementioned properties.

It has surprisingly been found that unexpectedly, an increased polarity of the PSA components leads to an improved water resistance in conjunction with equal bonding. The skilled person would expect a higher polarity to permit better water uptake, and hence would expect the PSA to fail on moist surfaces or in a moist environment. Surprisingly, an increased fraction of functional groups, more particularly groups which form hydrogen bonds, in the PSA results in improved water resistance of bonded articles comprising this PSA.

The achievement of the objects is described by the subject matter of the independent claims and is set out, furthermore, in specific form in the dependent claims, and also in detail in the description and in the examples.

It has been possible, surprisingly, to observe that when a PSA K based on acrylate polymers is used, the desired suitability on highly polar substrates, especially moist substrates, is achieved. Similar comments apply in respect of sheetlike bonding means and laser-writable articles.

The first aspect of the present invention, accordingly, is the use of a composition of the PSA K for bonding to high polarity surfaces, the PSA K being the product of crosslinking of a polymer material (PM) comprising at least the following components:
(A) at least one polymer component A comprising:
   (i) greater than or equal to 60 wt % to less than or equal to 80 wt %, based on the amount of polymer component A, of at least one component A1, component A1 comprising:
      (i-a) greater than or equal to 1 wt % to less than or equal to 15 wt %, based on the total amount of component A1, of at least one monomer a comprising compounds having at least one ethylenically unsaturated bond, and selected in each case such that the glass transition temperature T_{g} of the corresponding homopolymer of the respective monomer a is at least 0° C.,
      at least part of the total fraction of monomer a being present as at least one monomer a1 (not more than 15 wt % in the total amount of A1) comprising compounds having at least one ethylenically unsaturated bond and at least one carboxylic acid group (—COOH), and
      (i-b) greater than or equal to 85 wt % to less than or equal to 99 wt %, based on the total amount of component A1, of at least one monomer b selected from the group of acrylic esters and/or methacrylic esters, selected in each case such that the glass transition temperature T_{g} of the corresponding homopolymer of the respective monomer b is less than or equal to −30° C.,
   the (i-a) at least one monomer a and the (i-b) at least one monomer b being present in total with a fraction of 100 wt % in component A1 (A1=ad 100 wt %),
   (ii) greater than or equal to 20 wt % to less than or equal to 40 wt %, based on the amount of polymer component A, of at least one resin component A2,
the (i) at least one component A1 and the (ii) at least one resin component A2 being present in total with a fraction of 100 wt % in polymer component A (A=ad 100 wt %) and
(B) at least one crosslinker component B comprising covalently crosslinking di- or polyfunctional compounds,
   the (A) at least one polymer component A and the (B) at least one crosslinker component B being present in total with a fraction of greater than or equal to 95 wt % in the overall composition of the polymer material (PM=ad 100 wt %) and the high polarity surfaces comprising
(I) at least one hydroxyl, carbonyl, carboxyl, SH or NH group and/or at least one ionic group, and/or
(II) at least one adsorbed migratable compound containing at least one hydroxyl group.

In particular, the high polarity surface (synonymously: highly polar surface) comprises at least partly moisture-wetted surfaces and also wet surfaces.

In accordance with the invention, the PSA K adheres to high polarity surfaces, more particularly to (I) surfaces of mineral building materials and surfaces comprising at least one urea, amide and/or isocyanate group. The mineral building materials, which are of natural origin and are predominantly alkaline and/or porous, include lime, cement, gypsum, loam, lime sandstone comprising burnt lime and silica sand, ceramic building materials, caustic magnesia, anhydride, glass, and mixtures of at least two of the aforementioned building materials, or mixtures of natural fibres such as hemp fibre or cellulose fibre, for example. The surfaces comprising at least one urea, amide and/or isocyanate group include plastics, coatings and/or varnishes comprising one or more of the stated groups. Examples of such plastics are thermoplastics such as polyamides, thermosets such as polyurethanes, amino plastics such as polyurea and melamine.

Likewise a further aspect of the present invention is that the PSA K exhibits good flow onto and good bonding or adhesion on or to surfaces of high polarity such as at least partly moist or partly wetted or wet surfaces and also (II) surfaces comprising at least one adsorbed, migratable compound comprising at least one hydroxyl group, the aforesaid compound being selected from H₂O, H₂O in condensed phase, H₂O in vapour, steam, H₂O in aqueous solution, H₂O in crystalline form, H₂O in moisture, H₂O in a mixture comprising oil, H₂O in an emulsion, H₂O in a dispersion or H₂O in smoke, from at least one alcohol, or from an aqueous-alcoholic solution, compound comprising at least one hydroxyl group in mixtures with esters, and/or mixtures of at least two of the aforementioned components.

The aforementioned compounds comprising at least one hydroxyl group and adsorbed on the highly polar surfaces originate from the surrounding environment, especially liquids such as aqueous solvents, aqueous mixtures comprising the aforementioned compounds, for example from the engine compartment such as petrol or liquids with a small fraction of engine oil, cooling water, cooling fluid (glycerol, ethanol or ethylene glycol), anti-freeze agents, mixtures, aqueous mixtures comprising gases which have gone into solution from the engine compartment such as exhaust gases, aqueous mixtures comprising particles from the engine compartment such as abrasion from tyres, abrasion from brakes and fine dust, and aqueous mixtures as originating, for example, from a very familiar car wash; in addition, moist air, mist, atmospheric humidity, ice, ice particles, snow and melt water, rain, condensates, vapour, aerosols and also gritting salt in mixtures with the aforementioned aggregate states of water.

A particular subject of the present invention is that (II) the compounds comprising at least one described hydroxyl group, more particularly H₂O and H₂O-containing compounds, form hydrogen bonds with the PSA K. A further aspect of the present invention, therefore, is the use of the PSA K on highly polar surfaces, where the at least one carboxylic acid group (—COOH) of component A1 in the polymer material, with the polar surfaces and/or with the migratable compounds adsorbed on the polar surfaces, forms supramolecular structures based on a network of hydrogen bonds.

In particular, the H₂O molecules of the aforementioned adsorbed migratable compounds form hydrogen bonds with the carboxylic acid groups of the PSA K; in particular, the aforementioned compounds form extended supramolecular networks. The carboxylic acid groups come preferably from the component A1, more preferably from the monomer a1.

In sheetlike forms of the PSA, a multiplicity of such hydrogen bonds are formed, and a multi-dimensional network of hydrogen bonds is developed. A hydrogen bond network of this kind may come about locally, in the case of only partly H₂O-wetted surfaces, for example, or else may be formed in widely extended form and statistically over the entire bond face between the label and the surface to be marked, such as a component, for example. This is the case, for example, for a surface in a steam-saturated atmosphere.

The hydrogen bonds are formed between the described carboxylic acid group of the monomer a1 with the (I) surfaces of mineral materials and surfaces comprising at least one urea, amide and/or isocyanate group and/or (II) surfaces comprising at least one adsorbed, migratable compound comprising at least one hydroxyl group. The monomer a1 forming hydrogen bonds is preferably an acrylic acid, methacrylic acid or a mixture of the two.

A further aspect of the present invention is the use of PSA K, wherein component A1 comprises the (i-a) at least one monomer a which is selected from
(a1) a monomer a1 comprising ethylenically unsaturated compounds having a T_{g} of greater than or equal to 0° C. and at least one carboxylic acid group (—COOH),
(a2) a monomer a2 comprising ethylenically unsaturated compounds having a T_{g} of greater than or equal to 0° C. and at least one ester group, and/or
(a3) a monomer a3 comprising ethylenically unsaturated compounds having a T_{g} of greater than or equal to 0° C., without carboxylic acid group (—COOH) and ester groups,
   the fraction of the monomer a being greater than or equal to 1 wt % to less than or equal to 15 wt %, based on the total amount of component A1. More particularly the fraction is greater than or equal to 1 wt %, preferably greater than or equal to 3 wt %, based on the total amount of component A1. More preferably the fraction of monomer a in component A1 is greater than or equal to 3 wt % to less than or equal to 8 wt %, greater than or equal to 3 wt % and less than or equal to 5 wt %. In any case, here, component A1 comprises at least one monomer a1 which is present with a fraction of greater than or equal to 1 wt % to less than or equal to 8 wt %, more particularly greater than or equal to 1 wt %, preferably greater than or equal to 3 wt %, more preferably greater than or equal to 3 wt % to less than or equal to 8 wt %, greater than or equal to 3 wt % to less than or equal to 5 wt %, based on the total amount of component A1.

Very advantageously, the fraction of monomers a1 in component A1, in other words the fraction of monomers having at least one carboxylic acid group, is greater than or equal to 3 wt % to less than or equal to 5 wt %, based on component A1. A fraction of at least 3 wt % of monomers a containing carboxylic acid groups ensures a significant increase in reactivity in terms of the added crosslinker, and leads to good reaction rates in the crosslinking procedure. At the same time, an amount of greater than or equal to 3 wt % to less than or equal to 5 wt % of monomers a containing carboxylic acid groups ensures sufficient interaction with the highly polar surfaces, especially of the migratable and adsorbed compounds comprising at least one hydroxyl group, and hence ensures effective bonding as a result of the formation of an extended supramolecular structure between the moist surface and the PSA or the laser-writable and/or anti-counterfeit label or the film comprising the PSA K (see Examples, adhesive C, D and E).

In the context of the inventive use, in the bonding in particular of laser-writable and/or anti-counterfeit articles such as labels and films, for example, hydrogen bonds are formed between the migratable and adsorbed compounds comprising at least one hydroxyl group, more particularly H₂O or mixtures as already described above, and the carboxylic acid groups of the at least one monomer a1. The at least one monomer a1 preferably comprises compounds selected from the group of ethylenically unsaturated carboxylic acids comprising acrylic acid, methacrylic acid and/or mixtures of the two. Accordingly, the above-described network of hydrogen bonds is formed between the migratable and/or adsorbed hydroxyl-containing compounds and the carboxylic acid groups of the acrylic acid, methacrylic acid and/or mixtures of the two.

The network of the above-described hydrogen bonds leads, surprisingly, to a strong adhesion between the PSA K, more particularly a sheetlike bonding means obtainable therefrom, and the highly polar surfaces already described (Examples 3, 5 and 6). This constitutes particularly good adhesion of labels comprising the PSA K to the surfaces that are to be marked, such as components and electronic devices, especially in the automotive sector.

This is demonstrated by Examples 1 to 6, in which it is shown that an increased polarity of the PSA (as in adhesive C, D and adhesive E) leads to increased water resistance. The examples show, furthermore, that increased cohesion/flexibility of the PSA has a positive influence on the water resistance. In particular, relatively hard PSAs like that in adhesive A cannot flow so well onto the substrate or surface of a substrate, wet it and adhere, meaning that water is able more easily to penetrate the interface between PSA and substrate or surface, in particular through micropores and channels. The penetrating water interrupts the hydrogen bond network, with the consequence that the adhesion first goes down locally. This weakens the adhesion overall, and the shearing forces that occur at the transition from detached PSA to adhering PSA weaken the hydrogen bond network, this in turn possibly leading to a chain reaction and possibly causing complete detachment of the article such as the label.

Flexible PSAs such as adhesive D or E are able to flow very well onto a surface. In addition, a relatively high bonding time of greater than or equal to 1 hour, preferably greater than or equal to 24 hours, more preferably greater than or equal to 72 hours, promotes adhesion between the PSA and the substrate. The bonding time is the period within which flow, wetting and attachment of the PSA to the substrate is allowed, without exposure to disruption, more particularly to a force such as tensile or shearing force.

At the same time, the occurrence of air microbubbles is reduced by a longer bonding time, since the air is able to escape properly, especially in the case of relatively flexible PSAs such as in adhesive D. Reduction in air microbubbles leads to better adhesion of the PSA, owing to an increased number of molecular interactions in the form of hydrogen bonds. Accordingly, a strong hydrogen bond network leads to improved sealing, especially at the edges of the labels, meaning that less water is able to penetrate from outside. With the PSA K of the invention, therefore, a water-resistant laser-writable article is achieved, more particularly a label of this kind.

In one preferred embodiment, the adhesive, more particularly the PSA, has not only outstanding water resistance at 40° C. and 60° C. but also good high-temperature resistance at 90° C. (Examples 5 and 6).

For the formation of hydrogen bonds of this kind, component A1 may exclusively comprise monomers a1. It is also conceivable, however, for part of the monomers a1 to be replaced by a part of further comonomers (i-a), in each case selected such that the glass transition temperature T_{g} of the corresponding homopolymers of the respective monomer is at least 0° C., but having no carboxylic acid group (—COOH). This, however, should be only to the extent that at least 3 wt %, preferably at least 5 wt %, of the monomer a1, preferably acrylic acid, is retained in component A1.

In the sense of the comonomers (i-a) it is possible outstandingly to use, in part, monomers a2 selected from the group of the compounds having at least one ethylenically unsaturated bond, specifically such that the glass transition temperature T_{g} of the corresponding homopolymers of the respective monomer a2 is at least 0° C., the monomer a2 further having at least one ester group with an ethyl and/or methyl radical. The monomers in question are, in particular, acrylic and/or methacrylic esters, and so the group of the monomers a2 then comprises methyl acrylate, ethyl acrylate, methyl methacrylate and ethyl methacrylate. By means of the monomers a2, the polarity of the PSA K can be influenced.

Component A1 may comprise exclusively monomer a1, or may comprise exclusively monomer a1 and monomer a2. However, a part of the monomer a1, a part of the monomer a2 and a part of a further comonomer a3 may also be present in component A1. In that case, monomer a3 carries neither a carboxylic acid group (—COOH) nor an ester group with an ethyl and/or methyl radical. It is also possible for component A1 to comprise exclusively monomers a1 and a3. By means of the monomers a3, the glass transition temperature and/or the glass transition frequency of the resulting PSA K can be regulated in the direction of the value that is ultimately desired. In each case at least a fraction of greater than or equal to 3 wt % to less than or equal to 8 wt % of monomer a1 is retained in component A1.

As monomers a3 which comprise neither a carboxylic acid group (—COOH) nor an ester group with an ethyl and/or methyl radical, it is possible, by way of example and with no claim to completeness, to use the following monomers: benzyl acrylate, benzyl methacrylate, phenyl acrylate, phenyl methacrylate, isobornyl acrylate, isobornyl methacrylate, tert-butylphenyl acrylate, tert-butylphenyl methacrylate, cyclohexyl methacrylate, 3,3,5-trimethylcyclohexyl acrylate, 4-biphenylyl acrylate, 4-biphenylyl methacrylate, 2-naphthyl acrylate, 2-naphthyl methacrylate, phenoxyethyl acrylate, phenoxyethyl methacrylate, dimethylaminopropylacrylamide, dimethylaminopropyl-methacrylamide, and also N,N-dialkyl-substituted amides, such as, for example, N,N-dimethylacrylamide, acrylonitrile, vinyl ethers, such as vinyl methyl ether, ethyl vinyl ether, vinyl isobutyl ether, vinyl esters, styrene, α- and p-methylstyrene, macromonomers, such as 2-polystyrene-ethyl methacrylate (molecular weight M_{w} of 4000 to 13 000 g/mol), poly(methyl methacrylate)-ethyl methacrylate (M_{w} of 2000 to 8000 g/mol).

A further aspect of the present invention is the inventive use of the PSA K wherein the at least one monomer b having a T_{g} of less than or equal to −30° C. is selected from the group comprising acrylic esters having linear, branched and/or functional-group-substituted alkyl radicals, the linear alkyl radical having greater than or equal to 3 carbon atoms to less than or equal to 14 carbon atoms, preferably greater than or equal to 4 to less than or equal to 9 carbon atoms. The at least one monomer b is preferably selected from
(a) unsubstituted linear acrylic esters comprising methyl acrylate, butyl acrylate, propyl acrylate, n-pentyl acrylate, n-hexyl acrylate, n-heptyl acrylate, n-octyl acrylate, n-nonyl acrylate, n-decyl acrylate, n-undecyl acrylate, n-dodecyl acrylate, n-tridecyl acrylate, n-tetradecyl acrylate and/or
(b) branched unsubstituted and/or substituted acrylic esters comprising 2-heptyl acrylate, 2-octyl acrylate, ethylhexyl acrylate, 2-ethoxyethyl acrylate, 2-ethylhexyl acrylate, 2-ethylbutyl acrylate, 3-methoxybutyl acrylate, 2-methoxyethyl acrylate, 3-methoxypropyl acrylate, 3-methylbutyl acrylate and isodecyl acrylate.

The amount of monomer b in PSA K is greater than or equal to 87 wt % to less than or equal to 100 wt %, preferably 95 wt % to less than or equal to 97 wt %, based on the total amount of component A1.

Preferred unsubstituted linear esters of acrylic acid in the sense of monomer b are alkyl acrylates having an alkyl radical such as methyl, ethyl, propyl, butyl, pentyl and hexyl. Particularly preferred acrylic esters are methyl acrylate and butyl acrylate. Preferred branched esters of acrylic acid in the sense of monomer b are ethylhexyl ester and 2-ethoxyethyl acrylate.

Accordingly, component A1 comprises
(i-a) greater than or equal to 1 wt % to less than or equal to 15 wt %, based on the total amount of component A1, of at least one monomer a comprising compounds having at least one ethylenically unsaturated bond, selected in each case such that the glass transition temperature T_{g} of the corresponding homopolymer of the respective monomer a is at least 0° C., at least part of the total fraction of monomer a being present as at least one monomer a1 comprising compounds having at least one ethylenically unsaturated bond and at least one carboxylic acid group (—COOH), in particular with a fraction of at least 3 wt % to less than or equal to 8 wt %, based on the total amount of component A1, and
(i-b) greater than or equal to 85 wt % to less than or equal to 99 wt %, based on the total amount of component A1 (A1=ad 100 wt %), of at least one monomer b selected from the group of acrylic esters and/or methacrylic esters, selected in each case such that the glass transition temperature T_{g} of the corresponding homopolymer of the respective monomer b is less than or equal to −30° C.,
the (i-a) at least one monomer a and the (i-b) at least one monomer b being present in total with a fraction of 100 wt % in component A1 (A1=ad 100 wt %).

Preferred combinations of the monomers a and b in the composition of component A1 are, as monomer a1, acrylic acid and/or methacrylic acid, and, as monomer b, linear unsubstituted acrylic esters, preferably methyl acrylate and/or butyl acrylate, and also branched unsubstituted acrylic esters, preferably ethylhexyl acrylate, in each case independently with a T_{g} of less than or equal to −30° C.

Component A1 preferably comprises (wt % based on 100 wt % component A1):

Monomer a1: 3 wt % to 5 wt % acrylic acid

Monomer b:

| | |
|---|---|
| Butyl acrylate | 40 wt % to 48.5 wt % |
| | preferably 43.5 wt % to 48.5 wt % |
| | particularly 43.5 wt %, 47.5 wt % or 48.5 wt % |
| Ethylhexyl acrylate | 40 wt % to 48.5 wt % |
| | preferably 43.5 wt % to 48.5 wt % |
| | particularly 43.5 wt %, 47.5 wt % or 48.5 wt % |
| Methyl acrylate | 0.0 wt % to 15 wt % |
| | preferably 10 wt % |

The data for the glass transition temperatures T_{g} relate to the determination by means of dynamic mechanical analysis (DMA) at low frequencies (see later on; “Measurement Methods” section), unless individually stated otherwise.

The polymer component A (A=A1+A2) comprises not only component A1 but also a resin component A2. The fraction of resin component A2 in polymer component A is greater than or equal to 20 wt % to less than or equal to 40 wt %, more particularly greater than or equal to 20 wt %, 25 wt %, 30 wt % and 35 wt % or less than or equal to 40 wt %, the resin component A2 comprising one or more resins. Resins are considered for the purposes of the present invention to be oligomeric and polymeric compounds having a number-average molecular weight Mₙ of not more than 5000 g/mol (determined by gel permeation chromatography). In particular, the predominant part of the resins (based on the part by weight of the total resin component), and preferably all the resins, has/have a softening point of greater than or equal to 80° C. to less than or equal to 150° C. The data for the softening point Tₛ of polymeric compounds are given in relation to values determined by the ring & ball method as per ASTM E28-99 (2009), unless individually stated otherwise.

In the sense of resin component A2 it is possible to use natural and/or synthetic resins. In principle it is possible to use all resins whose softening point is within the stated temperature range. Suitable adhesive resins include, among others, rosin and rosin derivatives (rosin esters, also resin derivatives stabilized by disproportionation or hydrogenization, for example), polyterpene resins, terpene-phenolic resins, alkylphenolic resins, aliphatic, aromatic and aliphatic-aromatic hydrocarbon resins, to name but a few. Selected very preferably are resins which are compatible with the polyacrylate component, being more particularly soluble therein and/or homogeneously miscible therewith. In the sense of the present invention, terpene-phenolic resins are very suitable indeed. The admixing of a resin component may be used advantageously to regulate the glass transition range of the PSA (as a whole).

For the crosslinking of the PSA K, in order to obtain the product of crosslinking of the polymer material (PM=A+B), at least one difunctional or polyfunctional crosslinker (crosslinker component B) is added to the polymer component A, in a defined amount. The crosslinker is able, via the carbonyl group of the carboxylic acid groups of component A, more particularly via the introduced monomers a1, to effect covalent crosslinking.

In accordance with the invention, the at least one crosslinker is added to the PSA K in an amount such that the ratio V (V=nZ/nP) is in the range from 0.15 to 0.60. The value of V is preferably 0.2 or more, and is situated more particularly in the range from 0.22 to 0.58.

In one preferred embodiment, the PSA K is used in a composition in which the PSA K comprises the crosslinker component B with a quantitative ratio of V=nZ/nP between the amount of substance nZ of the crosslinking-active centres of the crosslinker to the theoretical amount of substance nP of the macromolecules of component A1 with a value of greater than or equal to 0.15 to less than or equal to 0.60, preferably greater than or equal to 0.38 to less than or equal to 0.59, where the amount of substance nZ of the crosslinking-active centres of the crosslinker is obtained from the mass mV of the crosslinker, multiplied by the number f of crosslinker-active centres per crosslinker molecule, divided by the molar mass MV of the crosslinker, i.e. nZ=f·mV/MV, and where the theoretical amount of substance nP of the macromolecules of component A1 is obtained from the mass mP of the polymer component in the PSA K, divided by the number-average molar mass Mn,P of this component, i.e. nP=mP/Mn,P, with the (A) at least one polymer component A and the (B) at least one crosslinker component B being present in total with a fraction of greater than or equal to 95 wt %, preferably 97 wt %, in the overall composition of the PSA K (K=ad 100 wt %).

In accordance with the invention it is also possible to use a plurality of crosslinkers. Where a plurality of crosslinkers are used, including, in particular, crosslinkers having different functionalities, the following should be placed in the definition of the above-described embodiment for the ratio V:

V=n_{Z}/n_{P},

where n_{Z} is the amount of substance of the crosslinking-active centres, summed across all of the crosslinkers:

n_{Z}=f₁·m_{V,1}/M_{V,1}f₂·m_{V,2}/M_{V,2} . . .

where the index 1 denotes the values of the first crosslinker, 2 those of the second crosslinker, etc.

Given knowledge of the number-average molecular weight (GPC) of the polymer sample, the amount of crosslinker can easily be determined, in accordance with the preferred embodiment of the PSA K, with knowledge of the average molecular weight of the crosslinker and of its functionality. Where there was only one crosslinker present, the initial mass of crosslinker advantageously used, my, is obtained, with the introduced definitions of the corresponding values, from the initial mass of the polymer component M_{P} and its number-average molar mass M_{n,P}, as follows (M_{V}=molecular weight of the crosslinker):

$${m}_{V} = \frac{V \cdot {m}_{P} \cdot {M}_{V}}{{M}_{n , P} \cdot f}$$

Where there is a plurality of crosslinkers, especially crosslinkers having different functionalities, this formula must be adapted accordingly. For the crosslinked PSA, the crosslinking density in good approximation corresponds on average to 0.15 to 0.60, preferably greater than or equal to 0.38 to less than or equal to 0.59, crosslinking sites per macromolecule of the polymer component, especially if the crosslinking reaction is carried through to a largely complete conversion.

The at least one crosslinker is a covalently crosslinking compound which is able to react with carboxyl groups and carboxylic acid groups. Selected with particular advantage as crosslinker component B is a chemically bonding (covalently crosslinking) system, in order to ensure sufficient temperature stability (in materials crosslinked with non-chemically bonding crosslinkers, chelate crosslinkers for example, the linkage sites would come apart again at high temperatures, causing the system to lose its cohesion properties). The crosslinker is therefore in particular a crosslinker capable of entering, via the carboxylic acid groups, into covalent bonds with the macromolecules of the polyacrylate; per functionality of the crosslinker molecule, one linkage site may be created (a difunctional crosslinker is able, therefore, to join two molecules to one another via two linkage sites, a trifunctional crosslinker three macromolecules via three linkage sites (in each case by means of one carboxylic acid group per macromolecule) or two macromolecules via three linkage sites (by means of one carboxylic acid group of one macromolecule and two carboxylic acid groups of the second macromolecule), and so on). It has emerged as being very advantageous if a crosslinking density is realized that corresponds on average per macromolecule of the polymer component to greater than or equal to 0.15 to less than or equal to 0.6, more particularly greater than or equal to 0.22 to less than or equal to 0.58, crosslinking sites. For this it is especially advantageous if the crosslinking reaction is carried through as far as possible in the direction of complete conversion (preferably greater than 90%, more preferably greater than 95%). With the advantageously realized degree of crosslinking, the cohesion of the crosslinked material is high enough that it does not split under flexural stress, but also low enough that flexural stress does not cause adhesive failure of the material (avoidance of overcrosslinking through appropriate choice of the number of crosslinking sites).

The crosslinker or crosslinkers are advantageously selected such that under standard storage conditions to which the non-crosslinked PSAs are frequently subject, they do not enter into any significant reactions with hydroxyl functions and/or, in particular, with water. In this way it is possible to prevent reductions in reactivity as a result of such reactions, as is frequently the case when using crosslinkers such as isocyanate.

Very suitable crosslinkers are those having three or four functional groups per crosslinker molecule (tri- and tetrafunctional crosslinkers). Particularly suitable crosslinkers, also with good storage qualities, have proved to be those chemical compounds which carry not only epoxy groups but also amine groups within them. Particularly suitable such crosslinkers have, for example, at least one amine group and at least two epoxy groups in the molecule; very much more effective crosslinkers have, for example, two amine groups and four epoxy groups. Having proved to be an outstandingly suitable crosslinker is N,N,N′,N′-tetraglycidyl-meta-xylenediamine (CAS No. 63738-22-7). Also very suitable is 1,3-bis(N,N-diglycidylaminomethyl)cyclohexane (CAS No. 65992-66-7). These crosslinkers with epoxy groups and amine groups in the molecule are notable for long stability (possible working time, “pot life”) of the crosslinker solution, do not exhibit any reduction in reactivity through actions with water, and are nevertheless characterized by a high crosslinking rate. Using these crosslinkers it is also possible to realize defined degrees of crosslinking in the target range of the present invention, without any significant post-crosslinking occurring during storage of the crosslinked products.

In order to ensure optimum crosslinking it is an advantage if apart from the selected covalently crosslinking crosslinkers there are no further crosslinkers present that react by other crosslinking mechanisms (such as chelate crosslinkers, for example). With particular preference the crosslinker component is tetraglycidyl-meta-xylenediamine.

In summary, the polymer material (PM) comprises at least one polymer component A and at least one crosslinker component B, hence PM=A+B.

The polymer component A comprises at least one component A1 and at least one resin component A2, hence A=A1+A2.

Component A1 comprises at least one monomer a and at least one monomer b, hence A1=a+b.

The monomer a comprises at least one monomer a1 and may further comprise other monomers a2 and monomers a3, hence a=a1+a2+a3.

Preparation of Component A1

Component A1, comprising polyacrylates, may be prepared by polymerization from the components described in accordance with the customary methods known to the skilled person, in particular by radical polymerization. The polymerization is preferably carried out such that the number-average molecular weight Mₙ of the resulting polymer is at least 50 000 g/mol. A level of 250 000 g/mol for the number-average molecular weight Mₙ is preferably not to be exceeded. Very preferably the number-average molecular weight Mₙ of component A1 is in a range between 50 000 g/mol and 150 000 g/mol. All data for molecular weights of polymers relate to the measurement by means of gel permeation chromatography; see later on, “Measurement methods” section.

Likewise, in the sense of the invention, the PSA K, as described above, is used in the form of at least one layer. More particularly it is in the form of a sheetlike bonding means comprising at least one layer, and has a layer thickness greater than or equal to 5 μm to less than or equal to 70 μm, preferably greater than or equal to 10 μm to less than or equal to 60 μm, more preferably greater than or equal to 10 μm to less than or equal to 30 μm. The layer thickness of the at least one layer is selected such that when the PSA K is used on highly polar surfaces, more particularly on surfaces having adsorbed migratable hydroxyl-containing compounds, sufficient adhesion or bonding is ensured, with the carboxylic acid groups of the at least one monomer a1, more particularly of acrylic acid, with a preferred fraction of greater than or equal to 3 wt % to less than or equal to 8 wt % in component A1, forming hydrogen bonds with the stated compounds comprising at least one hydroxyl group.

The sheetlike bonding means are formed from the PSA K by the preparation of the PSA K in a method known according to the prior art, by the application in one step of the PSA K to a substrate such as the manufacturing line or to a sheetlike element such as a support, more particularly a liner, the PSA K being applied to give at least one layer having a layer thickness of greater than or equal to 5 μm to less than or equal to 70 μm, preferably greater than or equal to 10 μm to less than or equal to 60 μm, more preferably greater than or equal to 10 μm to less than or equal to 30 μm (or the respectively corresponding weight per unit area in [g/m²]). In an optional step, the layer of PSA is cooled, to give, subsequently, a sheetlike bonding means of the PSA K. Optionally it is also possible for a protective layer such as a released liner to be applied to the layer of PSA.

The at least one layer of PSA is used preferably in accordance with the invention in the form of a sheetlike bonding means in a laser-writable multilayer article comprising films, diecuts and labels, preferably in laser-writable and anti-counterfeit labels and films, the article comprising at least the following layers:
(1) at least one engraving layer, more particularly comprising an acrylate varnish or a metal layer, having a preferred layer thickness of greater than or equal to 1 μm to less than or equal to 25 μm, preferably greater than or equal to 2 μm, greater than or equal to 3 μm, greater than or equal to 5 μm to less than or equal to 20 μm, to less than or equal to 15 μm, more preferably greater than or equal to 3 μm to less than or equal to 10 μm,
(2) at least one contrast layer, which in particular comprises a varnish, preferably an acrylate varnish, and is disposed below the engraving layer, and
(3) at least one adhesive layer comprising the PSA K, disposed below the contrast layer.

The (3) layer of PSA preferably comprises monomer a1, preferably acrylic acid and/or methacrylic acid, with a fraction of greater than or equal to 3 wt % to less than or equal to 8 wt %, based on the total amount of component A1.

In a further embodiment, the PSA K is used in accordance with the invention in a laser-writable multilayer article in which, in addition to the aforementioned layers,
(1.1) a support film, preferably comprising a thermoset plastic such as polyester and polyamide, in the form of a film, on which (1) engraving layer is disposed, the support carrier film being individually printable,
(1) the engraving layer comprises a preferably solvent-free, radiation-curable varnish, preferably an electron- and/or UV-curable varnish,
(2) the contrast layer comprises an electron beam-curable varnish, in particular with a layer thickness of greater than or equal to 20 μm to less than or equal to 500 μm, preferably greater than or equal to 30 μm to less than or equal to 300 μm, more preferably greater than or equal to 30 μm to less than or equal to 100 μm, the engraving layer and contrasting layer contrasting very greatly with one another,
(3) the adhesive layer has a thickness of greater than or equal to 7 μm to less than or equal to 70 μm, preferably greater than or equal to 10 μm to less than or equal to 60 μm, more preferably greater than or equal to 10 μm to less than or equal to 30 μm, and
(4) optionally a protective layer, preferably a siliconized paper, a siliconized film or a silicone film, is applied on the adhesive layer.

Preferably the (3) layer of PSA comprises monomer a1, preferably acrylic acid and/or methacrylic acid, with a fraction of greater than or equal to 3 wt % to less than or equal to 8 wt %, based on the total amount of component A1.

Laser-writable articles encompass products, more particularly adhesive tapes, cable wrapping tapes, signs, labels and films, into which markings such as text, codes and the like are burnt by means of powerful, controllable lasers (for example Nd:YAG lasers or CO₂ lasers). Laser-writable articles of these kinds, especially labels, are used particularly for rational and variable inscription for the production of plate sets. These plate sets contain the complete number of labels which are required, for example, in a motor vehicle on components liable to identification (VIN plate, plates relating to tyre pressure, type of fuel, boot loading, characteristic data on various components of motor vehicles, such as engines and assemblies, etc.). Such labels and/or films are likewise used as model plates, as control labels for process sequences, and also as guarantee badges and testing plaquettes.

In addition to such technical information, laser-writable labels and films may also contain safety information such as chassis and vehicle identification numbers. Such labels, in the event of a theft or accident, provide information relating to the vehicle and manufacturing stages in its production. The use of special security features, such as holograms, lasting UV footprints on the substrate to which the label was bonded, and specific selection of material for the laser-writable labels are all used first to make it more difficult to copy the material and secondly to indicate attempts at manipulation. Anti-counterfeit laser-writable labels and films of these kinds may be or are characterized by individualization or an originality feature, preferably on and/or in the engraving layer. Preferably, such originality features are not directly visible, but instead require a greater or lesser level of apparatus in order to be recognized and thus to provide the proof of originality. Thus, for example, the engraving layer may comprise dyes which fluoresce in ultraviolet light, for example, and which become visible when eliminated with a UV lamp. Another example are thermochromic dyes, which change their colour on heating. It is also conceivable for the varnish of the engraving layer to be doped with other detectable substances which are able to supply proof of originality, as for example of substances such as “Biocode” or “Microtaggent”. Marketed under the brand name “Biocode” by the Biocode company is a system with agent, marker and receptor that allows specific verification in the context of biological samples. “Microtaggent” is a brand name of the Microtrace Inc. company for a pigment with multilayer colouring, which reveals a customer-specific colour code only when viewed under a microscope. These originality features are known per se and are available in a variety of embodiments. They can be put to diverse use for the unambiguous identification and marking of products.

The (1) engraving layer is a layer which is disposed above the (2) contrast layer and which can be inscribed by means of a single laser beam or by means of two or more laser beams. In this inscribing operation, the engraving layer is at least partly ablated at those points on which a laser beam is directed with corresponding energy. Given sufficient energy input, the engraving layer is completely removed locally, and so is light-transmissive at these points. It is likewise conceivable for the engraving layer to be only partly ablated at certain points, producing an opaque appearance of the engraving layer at these points. The engraving layer is preferably a varnish layer, which can be applied by means of printing processes. Preferred examples of such print varnish layers comprise print varnishes based on electron beam-curable or UV-curable acrylate varnishes such as, in particular, polyurethane acrylate varnishes. In an alternative embodiment of the invention, the engraving layer consists of a thin metal layer. The engraving layer preferably has a thickness of greater than or equal to 1 μm to less than or equal to 30 μm, preferably greater than or equal to 1 μm to less than or equal to 20 μm, more preferably greater than or equal to 1 μm to less than or equal to 10 μm. If the thickness of the engraving layer is within this range, it is possible to provide a particularly temperature-stable laser-writable film, which at the same time is also water-resistant in combination with the PSA K containing carboxylic acid groups. In comparison to the contrast layer, which preferably has a thickness of greater than or equal to 20 μm to less than or equal to 300 μm, preferably greater than or equal to 40 μm to less than or equal to 200 μm, more preferably greater than or equal to 60 μm to less than or equal to 150 μm, the thickness of the engraving layer is preferably, for example, 10% of the thickness of the contrast layer or less. The completed film has the engraving layer exposed, i.e. at the top.

In one preferred embodiment, the (1.1) support film comprises printing, with the printing on the support carrier film having a height of greater than or equal to 0.1 μm to less than or equal to 15 μm, preferably a height of greater than or equal to 1 μm to less than or equal to 5 μm. In particular, the impression of the printed support carrier film is present as a depression in the (1) engraving layer, with the depression having a depth of less than or equal to 0.1 μm to less than or equal to 15 μm, preferably greater than or equal to 1 μm to less than or equal to 5 μm.

In one preferred embodiment of the laser-writable, water-resistant, multilayer article, the (2) contrast layer comprises a cured acrylate varnish composition which is based on a composition comprising greater than or equal to 30 wt % to less than or equal to 80 wt %, preferably greater than or equal to 50 wt % to less than or equal to 60 wt %, more preferably greater than or equal to 52 wt % to less than or equal to 58 wt % of a trifunctional oligomer A, greater than or equal to 0 wt % to less than or equal to 20 wt %, preferably greater than or equal to 5 wt % to 15 wt %, more preferably greater than or equal to 8 wt % to less than or equal to 12 wt % of a trifunctional monomer B, greater than or equal to 1 wt % to less than or equal to 30 wt %, preferably greater than or equal to 5 wt % to less than or equal to 15 wt %, more preferably greater than or equal to 8 wt % to less than or equal to 12 wt % of a difunctional monomer C, and also greater than or equal to 2 wt % to less than or equal to 40 wt % of a colouring pigment. The contrast layer of laser-writable, water-resistant, multilayer articles of the invention, more particularly films, can be provided by curing a composition comprising components A, B and C and also the colouring pigment. For this purpose the composition is crosslinked by means of UV radiation, electron beam curing (EBC hereinafter), or thermally. Crosslinking is accomplished preferably by means of EBC.

The contrast layer comprises at least one colouring pigment. Colouring pigments in the sense of the present invention encompass, without restriction, all colouring pigments which find application as dyes and/or brighteners in paints and inks. Examples of colouring pigments are titanium dioxide in the rutile modification (“TiO₂”, examples being rutile types from Kronos), pigmentary carbon blacks (examples being Printex types from Evonik) or other colouring pigments known to the skilled person, as specified, for example, in Lehrbuch der Lacke and Beschichtungen Volume 5 (Hans Kittel and Jurgen Spille, Hirzel Verlag (Stuttgart), 2003). The colouring pigment preferably comprises very weathering-stable pigments. Particularly preferred for the contrast layer is titanium dioxide in the rutile modification. Key to the invention is not the colour of the pigment or of the contrast layer per se, but rather the contrast or colour difference that arises in comparison to the engraving layer. The pigment used in accordance with the invention serves for the setting of the contrast which is produced between the contrast layer and the engraving layer after the inscription of the film, in other words after laser ablation of the engraving layer.

In a further embodiment of the present invention, the laser-writable, water-resistant, multilayer article further comprises an intermediate layer which is disposed between the engraving layer and contrast layer. The intermediate layer is an additional varnish layer comprising preferably a pigmented, electron beam-curable varnish, preferably a pigmented, electron beam-curable polyurethane acrylate varnish.

Where necessary, the laser-inscribable, water-resistant, multilayer article has a compensation layer, which is disposed between the contrast layer and the adhesive layer, in order to compensate stresses occurring within the label, so that tearing or detachment does not occur. A compensation layer of this kind has reversible flexibility, since at temperatures of up to 50° C. it is solid and at higher temperatures it softens or melts and is capable of compensating stresses that arise. The compensation layer consists preferably of thermoplastics such as polyvinyl acetate or polyamide, for example. Also suitable are all plastics consisting of linear or thermolabilely crosslinked polymer molecules, for example polyolefins, vinyl polymers, polyesters, polyacetates, polycarbonates or else polyurethanes and ionomers. As thermoplastics for the compensation layer it is also possible for thermoplastically processable plastics having pronounced entropy-elastic properties, referred to as thermoplastic elastomers, to be used. The properties of the compensation layer can be varied widely by additions of plasticizers, fillers, stabilizers and other additives and also by fibre reinforcement. The compensation layer may be coated from solution or inserted as a film between carrier layer and PSA. The compensation layer preferably has a layer thickness of greater than or equal to 0.2 μm to less than or equal to 20 μm. In another preferred embodiment, the weight per unit area is greater than or equal to 0.5 g/m² to less than or equal to 5 g/m². The compensation layer is capable of compensating the stresses within the label that arise in particular at high temperatures, by becoming soft or melting from a particular temperature range onwards. On the basis of this plastic behaviour, the stresses within the compensation layer are dissipated. Accordingly, the label is flexible at high temperatures. If the label or the substrate subsequently cools down again, the compensation layer enters the solid state, so that the bond strength of the label is not adversely affected in any way. The melting and subsequent solidifying of the compensation layer can be repeated virtually as often as desired.

A particular aspect of the present invention is that in the water stress test, the sheetlike bonding means comprising the PSA K has a water resistance of greater than or equal to 100 h, preferably greater than or equal to 200, 300, 400, 500, 600, 700, 800, 900 h, at greater than or equal to 40° C., preferably 45° C., 50° C. and 55° C., to less than or equal to 1000 h at less than or equal to 60° C. (see Examples 1, 5 and 6). In the water stress test, the sheetlike bonding means is preferably water-resistant for 1000 hours at greater than or equal to 40° C. With preference, no more than reversible blistering, especially without change in the material, is observed.

In particular, in the sense of the present invention, in the water stress test, the sheetlike bonding means exhibits no more than reversible blistering, removable by gentle pressure applied to the bonding means (see FIG. 6 to FIG. 10), after greater than or equal to 100 h at greater than or equal to 40° C. to less than or equal to 1000 h at less than or equal to 60° C. With preference no edge lifting is observed and the sheetlike bonding means remains adhering with no adverse effect, more particularly over the full area (see FIG. 8 d)). In particular, in the high-temperature water stress test, the sheetlike bonding means exhibits a water resistance, with no more than slight edge lifting and preferably slight blistering occurring, more particularly reversible blistering (Example 5), after 15 minutes at greater than or equal to 80° C. to less than or equal to 100° C.

In one particular version of the invention, after direct water stress exposure as in the water stress test at 100° C., there is slight blistering and/or slight edge lifting. This blistering and edge lifting, however, are reversible, and the sheetlike bonding means and the article such as the label comprising in each case the PSA again acquire full-area adhesion (see FIG. 9 and FIG. 10 and also Table 3) after a rehabilitation phase, in particular after a reconditioning time of greater than or equal to 15 minutes to less than or equal to 72 hours.

The reconditioning time is greater than or equal to 15 minutes, greater than or equal to 30 minutes, greater than or equal to 1 hour, greater than or equal to 12 hours, greater than or equal to 24 hours to less than or equal to 48 hours, less than or equal to 60 hours, less than or equal to 72 hours.

In a further embodiment of the PSA of the invention, it exhibits good water resistance in the high-temperature water stress test, the temperatures being greater than or equal to 70° C. to less than or equal to 120° C., preferably greater than or equal to 75° C. to less than or equal to 110° C., more preferably greater than or equal to 80° C. to less than or equal to 100° C. At the aforementioned temperatures the water resistance is preferably of a quality such that the bonded PSA, more particularly the sheetlike bonding means, and the article of the invention exhibit only slight edge lifting, preferably only slight blistering, there being more preferably no change in the material (see Table 4). The terms “water resistance” and “water-resistant” are used synonymously.

In one particular embodiment, the PSA of the invention, more particularly the sheetlike bonding means, is used in combination with a laser film, the laser film exhibiting reversible water absorption, measured by coulometric Karl-Fischer titration after immersion of the laser films in water at 50° C. for 3 days (Example 4). Water absorption is evident from swelling of the laser film; with preference, the laser film is able to accommodate water up to twice the amount of its original water content. The water absorption is preferably reversible, preferably completely reversible, after a reconditioning time of greater than or equal to 60 minutes to less than or equal to 24 hours, and the laser film reacquires its original shape and original water content.

Likewise a subject of the present invention is a water-resistant, laser-writable and multilayer article comprising at least the following layers:
(1) at least one engraving layer, in particular comprising an acrylate varnish or a metal layer, having a preferred layer thickness of greater than or equal to 1 μm to less than or equal to 20 μm, preferably greater than or equal to 5 μm to less than or equal to 15 μm,
(2) at least one contrast layer, which in particular comprises a varnish, preferably an acrylate varnish, and is disposed below the engraving layer, and
(3) at least one adhesive layer comprising the PSA K, disposed below the contrast layer, the PSA K being the product of crosslinking of a polymer material comprising at least the following components:
   (A) at least one polymer component A comprising:
      (i) greater than or equal to 60 wt % to less than or equal to 80 wt %, based on the amount of polymer component A, of at least one component A1, component A1 comprising:
         (i-a) greater than or equal to 3 wt % to less than or equal to 15 wt %, based on the total amount of component A1, of at least one monomer a comprising compounds having at least one ethylenically unsaturated bond, and selected in each case such that the glass transition temperature T_{g} of the corresponding homopolymer of the respective monomer a is at least 0° C., at least part of the total fraction of monomer a being present as at least one monomer a1 comprising compounds having at least one ethylenically unsaturated bond and at least one carboxylic acid group (—COOH), preferably with a fraction of greater than or equal to 3 wt % to less than or equal to 8 wt %, based on the total amount of component A1, of the at least one monomer a1, and
         (i-b) greater than or equal to 85 wt % to less than or equal to 97 wt %, based on the total amount of component A1, of at least one monomer b selected from the group of acrylic esters and/or methacrylic esters, selected in each case such that the glass transition temperature T_{g} of the corresponding homopolymer of the respective monomer b is less than or equal to −30° C.,
      the (i-a) at least one monomer a and the (i-b) at least one monomer b being present in total with a fraction of 100 wt % in component A1 (A1=ad 100 wt %),
      (ii) greater than or equal to 20 wt % to less than or equal to 40 wt %, based on the amount of polymer component A, of at least one resin component A2,
   the (i) at least one component A1 and the (ii) at least one resin component A2 being present in total with a fraction of 100 wt % in polymer component A (A=ad 100 wt %), and
   (B) at least one crosslinker component B comprising covalently crosslinking di- or polyfunctional compounds,
the (A) at least one polymer component A and the (B) at least one crosslinker component B being present in total with a fraction of greater than or equal to 95 wt % in the overall composition of the polymer material (PM=ad 100 wt %).

In one preferred embodiment, the water-resistant, laser-writable, multilayer article has an adhesive layer of the PSA K, comprising as monomer a1 at least one acrylic acid and/or methacrylic acid with a fraction of greater than or equal to 3 wt % to less than or equal to 15 wt %, based on the total amount of component A1, preferably with a fraction of greater than or equal to 3 wt % to less than or equal to 8 wt %. More preferably the article of the invention comprises as monomer a1 acrylic acid with a fraction of greater than or equal to 3 wt % to less than or equal to 8 wt %, based on the total amount of component A1.

In one particular embodiment of the water-resistant, laser-writable, multilayer article, the contrast layer is based on a cured acrylate varnish composition, as already described above, comprising
(a) greater than or equal to 30 wt % to less than or equal to 80 wt % of a trifunctional oligomer A
(b) greater than or equal to 0 wt % to less than or equal to 20 wt % of a trifunctional monomer B
(c) greater than or equal to 1 wt % to less than or equal to 30 wt % of a difunctional monomer C and
(d) greater than or equal to 2 wt % to less than or equal to 40 wt % of a colouring pigment.

The trifunctional oligomer A is an oligomer having three unsaturated (meth)acrylate units per molecule, whose number-average molecular weight Mn is preferably greater than or equal to 1000 g/mol to less than or equal to 5000 g/mol, preferably greater than or equal to 1400 g/mol to less than or equal to 3600 g/mol, preferably greater than or equal to 1800 g/mol to less than or equal to 2200 g/mol, more preferably greater than or equal to 1900 g/mol to less than or equal to 2100 g/mol. When the molecular weight Mn is within the stated range, this has a positive influence on the long-term temperature stability of the cured acrylate varnish composition, allowing particularly dimensionally stable contrast layers to be obtained.

In one preferred embodiment, the trifunctional oligomer A is selected from the group of polyurethane tri(meth)acrylates and polyester tri(meth)acrylates, of which polyurethane tri(meth)acrylates are particularly preferred. The expression “(meth)acrylate” encompasses acrylates, methacrylates and mixtures thereof. With preference the trifunctional oligomer A is a polyurethane tri(meth)acrylate, more preferably a polyurethane triacrylate. Polyurethane tri(meth)acrylates are oligomers having in each case three unsaturated (meth)acrylate groups per molecule and also a plurality of, in other words at least two, urethane units. Examples of preferred polyurethane triacrylates are the aliphatic urethane triacrylates CN9260D75® and CN9278D80® from Sartomer, of which CN9260D75® is particularly preferred.

The trifunctional monomer B comprises three unsaturated (meth)acrylate units per molecule and in one preferred embodiment of the invention has a molecular weight of greater than or equal to 300 g/mol to less than or equal to 1000 g/mol, preferably 350 g/mol to less than or equal to 800 g/mol, preferably greater than or equal to 350 g/mol to less than or equal to 600 g/mol, more preferably greater than or equal to 400 to 450 g/mol. Component B is preferably selected from the group consisting of propoxylated and ethoxylated glycerol tri(meth)acrylates and propoxylated and ethoxylated trimethylolpropane tri(meth)acrylates of the general formula (I), or mixtures thereof:

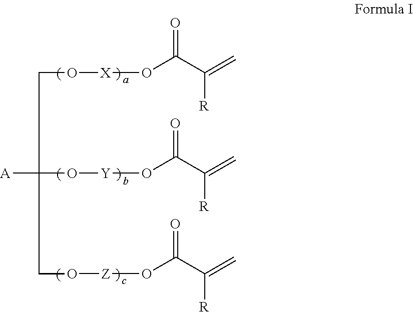

where R in formula I is hydrogen or a methyl group; A is hydrogen or an ethyl group; X, Y and Z in each case independently of one another are a propylene or ethylene unit; and a, b and c in each case independently of one another are an integer from 1 to 4, preferably 1 to 3, and a+b+c is a number between 3 and 12, preferably from 3 to 9. In one particularly preferred embodiment of the invention, X, Y and Z are propylene units. With particular preference the trifunctional monomer is a propoxylated glycerol triacrylate. If the trifunctional monomer B is selected such that the molecular weight is within the above-stated ranges and/or such that the monomer B falls within the above-stated formula I, then component B as well exerts a positive influence on the temperature stability of the contrast layer and hence of the laser-writable film.

The difunctional monomer C is a monomer having two unsaturated acrylate units per molecule. Component C preferably has a molecular weight of greater than or equal to 100 g/mol to less than or equal to 1000 g/mol, preferably greater than or equal to 180 g/mol to less than or equal to 350 g/mol, more preferably greater than or equal to 220 g/mol to less than or equal to 280 g/mol, and is preferably selected from the group of the ethylene glycol diacrylates of the general formula (II):

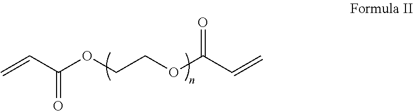

and of the propylene glycol diacrylates of the general formula (III):

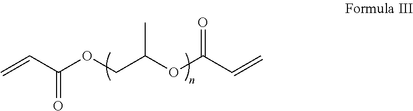

or mixtures thereof, with n in the formulae II and III in each case independently of one another being an integer from 1 to 15, preferably from 1 to 9, more preferably from 2 to 6 and very preferably 3 or 4. In one particularly preferred embodiment of the present invention, the difunctional monomer C is triethylene glycol diacrylate. If the difunctional monomer C is selected such that the molecular weight falls within the above-stated ranges and/or such that the monomer C falls within the above-stated formula II or III, then component C as well exerts a positive influence on the temperature stability of the contrast layer and hence of the laser-writable film.

In one particularly preferred embodiment of the invention, the contrast layer in the laser-writable, water-resistant and multilayer article is based on a composition comprising at least one polyurethane triacrylate, preferably CN9260D75® or CN9278D80® from Sartomer, as component A, a propoxylated glycerol triacrylate of the formula I reproduced above, as component B, triethylene glycol diacrylate as component C, and also a pigment, for example titanium dioxide in the rutile modification.

The water-resistant, laser-writable, multilayer article is preferably in the form of a label, a film and/or a diecut and is preferably at the same time anti-counterfeit, in particular by means of individualizations, as already described above.

In one preferred embodiment, the laser-writable, water-resistant and multilayer article, more particularly the bonding means of the invention and also, in particular, the PSA K of the invention, has a heat resistance of greater than 200 hours to less than or equal to 2500 hours at greater than or equal to 80° C. to less than or equal to 150° C., preferably greater than or equal to 300 hours to less than or equal to 2300 hours, greater than or equal to 500 hours to less than or equal to 2500 hours. More preferably the heat resistance is from greater than or equal to 500 hours to less than 1000 hours at 80° C. and greater than or equal to 500 hours to less than 2300 hours at 150° C. The heat resistance is manifested in particular in low to zero deformation or no tearing of the article, the article at most having creases; preferably, the bar code of the article is legible.

In one preferred embodiment, the laser-writable, water-resistant and multilayer article, more particularly the bonding means of the invention and further, in particular, the PSA K of the invention, additionally has a resistance to exposure to liquids for greater than or equal to 24 hours at room temperature relative to greater than or equal to 2.5% strength and less than or equal to 5% strength H₂SO₄, and also relative to glass cleaning agents, 1% strength aqueous sodium hydroxide solution, petrol, toluene, engine oil/machine oil, diesel fuels, and other fluids customary in the automotive sector. The above-described resistance preferably exists at temperatures of greater than or equal to 20° C. to less than or equal to 50° C. and for greater than or equal to 15 minutes to less than or equal to 24 hours, preferably for greater than or equal to 30 minutes to less than or equal to 12 hours.

In one preferred embodiment, the laser-writable, water-resistant and multilayer article, more particularly the bonding means of the invention and further, in particular, the PSA K of the invention likewise exhibits outstanding abrasion resistance. In particular, the article of the invention, in an abrasion test with 200 g weight and 200 repetitions of forward and backward rubbing, exhibits no change in the material; preferably, the bar code is legible.

In one preferred version, the laser-writable article of the invention comprising the described sheetlike bonding means comprising the PSA K meets the requirements of the German motor transport office for “plant plates” in accordance with the bulletin for the testing of plant plates made from plaques, metal sheets and foils, and their fastening by adhesive bonding, as at July 2007.

The article of the invention exhibits good water resistance in the high-temperature water stress test at 100° C. for 15 minutes, with the article exhibiting at most slight edge lifting, preferably a slight and reversible blistering. The article of the invention preferably has an adhesive force, measured as peel force to ISO 29862 (method 1, peel speed of 300 mm/min) of greater than or equal to 5 N/cm at 23° C., more particularly greater than or equal to 5 N/cm at less than or equal to 40° C., preferably greater than or equal to 4 N/cm at 70° C. and greater than or equal to 3 N/cm at 100° C.

In the inventive use of the water-resistant, laser-writable and multilayer article comprising labels, films, adhesive tapes and diecuts, this article in the water stress test has a water resistance of greater than or equal to 100 h at 40° C., more particularly up to greater than or equal to 1000 hours, preferably greater than or equal to 200, 300, 400, 500, 600, 700, 800, 900 hours, preferably at greater than or equal to 45° C., 50° C. and 55° C. to less than or equal to 60° C., and/or has a water resistance in the high-temperature water stress test of greater than or equal to 15 minutes at greater than or equal to 80° C. to less than or equal to 100° C.

The good resistance in the water stress test at greater than or equal to 100 h at greater than or equal to 40° C. to less than or equal to 1000 h, more particularly at less than or equal to 60° C., is preferably manifested with at most reversible blistering, which can be removed by gentle pressing. Preferably, in the water stress test, no edge lifting is visible (see Example 1, Table 1; Example 5, Table 5; Example 6 and FIGS. 6 to 10) in the water-resistant, laser-writable and multilayer article, in the sense of the invention.

In one particular version of the invention, there is slight blistering and/or slight edge lifting, but reversible after a rehabilitation phase, following direct water stress exposure, as in the water stress test. The article described above comprising the PSA regains full-area adhesion (see FIG. 9 and FIG. 10 and also Table 3) after a rehabilitation phase, more particularly after a reconditioning time, of greater than or equal to 15 minutes to less than or equal to 72 hours.

The reconditioning time is preferably greater than or equal to 15 minutes, greater than or equal to 30 minutes, greater than or equal to 1 hour, greater than or equal to 12 hours, greater than or equal to 24 hours to less than or equal to 48 hours, less than or equal to 60 hours, less than or equal to 72 hours.

In a further embodiment of the article of the invention, it exhibits good water resistance in the high-temperature water stress test, with the temperatures amounting to greater than or equal to 70° C. to less than or equal to 120° C., preferably greater than or equal to 75° C. to less than or equal to 110° C., more preferably greater than or equal to 80° C. to less than or equal to 100° C. At the aforementioned temperatures, the water resistance is preferably of a quality such that the bonded article of the invention exhibits only slight edge lifting, preferably only slight blistering, more preferably no change occurring in the material (see Table 4).

Water-resistant, laser-writable and multilayer articles of the invention can be produced in a variety of ways. In one embodiment, the present invention relates to a method for producing a water-resistant multilayer article, more particularly laser-writable and preferably anti-counterfeit as well, and also to an article obtainable by this method, comprising the following steps:
1) optionally providing a support film;
2) applying an engraving layer, more particularly varnish layer or metal layer, to the support film;
3) applying a composition for producing a contrast layer, more particularly an acrylate varnish composition, to the engraving layer;
4) curing the composition from step 3), to give a contrast layer;
5) applying a PSA K to the contrast layer and covering the PSA K with a protective paper or release liner, the PSA K being the product of crosslinking of a polymer material comprising at least the following components:
   (A) at least one polymer component A, comprising:
      (i) greater than or equal to 60 wt % to less than or equal to 80 wt %, based on the amount of polymer component A, of at least one component A1, component A1 comprising:
         (i-a) greater than or equal to 3 wt % to less than or equal to 15 wt %, based on the total amount of component A1, of at least one monomer a comprising compounds having at least one ethylenically unsaturated bond, and selected in each case such that the glass transition temperature Tg of the corresponding homopolymer of the respective monomer a is at least 0° C., at least part of the total fraction of monomer a being present as at least one monomer a1 comprising compounds having at least one ethylenically unsaturated bond and at least one carboxylic acid group, preferably with a fraction of greater than or equal to 3 wt % to less than or equal to 8 wt %, based on the total amount of component A1, of the at least one monomer a1, and
         (i-b) greater than or equal to 85 wt % to less than or equal to 97 wt %, based on the total amount of component A1, of at least one monomer b selected from the group of acrylic esters and/or methacrylic esters, selected in each case such that the glass transition temperature Tg of the corresponding homopolymer of the respective monomer b is less than or equal to −30° C.,
      the (i-a) at least one monomer a and the (i-b) at least one monomer b being present in total with a fraction of 100 wt % in component A1 (A1=ad 100 wt %),
      (ii) greater than or equal to 20 wt % to less than or equal to 40 wt %, based on the amount of polymer component A, of at least one resin component A2,
   the (i) at least one component A1 and the (ii) at least one resin component A2 being present in total with a fraction of 100 wt % in polymer component A (A=ad 100 wt %), and
   (B) at least one crosslinker component B comprising covalently crosslinking di- or polyfunctional compounds,
the (A) at least one polymer component A and the (B) at least one crosslinker component B being present in total with a fraction of greater than or equal to 95 wt % in the overall composition of the polymer material (PM=ad 100 wt %),
6) and removing the support film.

In this method, conventional films based on various materials, such as polyethylene terephthalate (PET), may be used as a support film, also referred to as process liner. The application both of the engraving layer to the support film and of the acrylate varnish composition to the engraving layer may take place by means of conventional printing and coating processes. In one preferred embodiment of the invention, the acrylate varnish composition is applied using a comma bar.

In one preferred embodiment of the method for producing a water-resistant multilayer article of the invention, in step 3) of the method a composition is applied comprising
(a) greater than or equal to 30 wt % to less than or equal to 80 wt % of a trifunctional oligomer A
(b) greater than or equal to 0 wt % to less than or equal to 20 wt % of a trifunctional monomer B
(c) greater than or equal to 1 wt % to less than or equal to 30 wt % of a difunctional monomer C and
(d) greater than or equal to 2 wt % to less than or equal to 40 wt % of a colouring pigment.

Optionally, in the method for producing a water-resistant multilayer article of the invention, the intermediate layer is applied after the application of the engraving layer and before the application of the contrast layer, which preferably has a pigmented, electron beam-curable varnish, and/or the compensation layer is applied after the application of the contrast layer and before the application of the adhesive layer, which preferably comprises a thermoplastic polymer.

The invention is elucidated in more detail by working examples which are set out and described below. The examples are intended to outline the invention, without the invention being confined to the values stated in the examples.

### THE FIGURES

FIG. 1, FIG. 2, FIG. 3 and FIG. 4 show the construction of an article of the invention.

FIG. 5 shows the experimental setup of the water stress test.

FIGS. 6a) and 6b), FIGS. 7a) and 7b), FIGS. 8a) to 8d) show the photographic documentation of test adhesive tapes in the water stress test, each bonded to a ASTM steel test surface.

FIGS. 9a) and 9b) and also FIGS. 10a) and 10b) show the photographic documentation of test adhesive tapes in the high-temperature water stress test, each bonded to an ASTM steel test surface.

### REFERENCE NUMERALS

0 denotes the general construction of a label in the sense of the invention; 1.1, 1.2, 1.3 and 1.4 each denote an engraving layer of the invention; 2.1, 2.2, 2.3 and 2.4 each denote the adhesive layer of the invention; 3.1, 3.2, 3.3 and 3.4 each denote the contrast layer of the invention; and 4.2, 4.3 and 4.4 each denote a protective layer. 5 denotes test adhesive tapes, 6 test surfaces, 7 sample holder, 8 distilled water, 9 temperature sensor, 10 thermometer and 20 oven.

### DESCRIPTION OF THE FIGURES

The figures show general and preferred embodiments of a water-resistant, multilayer, laser-writable article, more particularly a label of that kind, which is used for bonding to moist and/or wet surfaces.

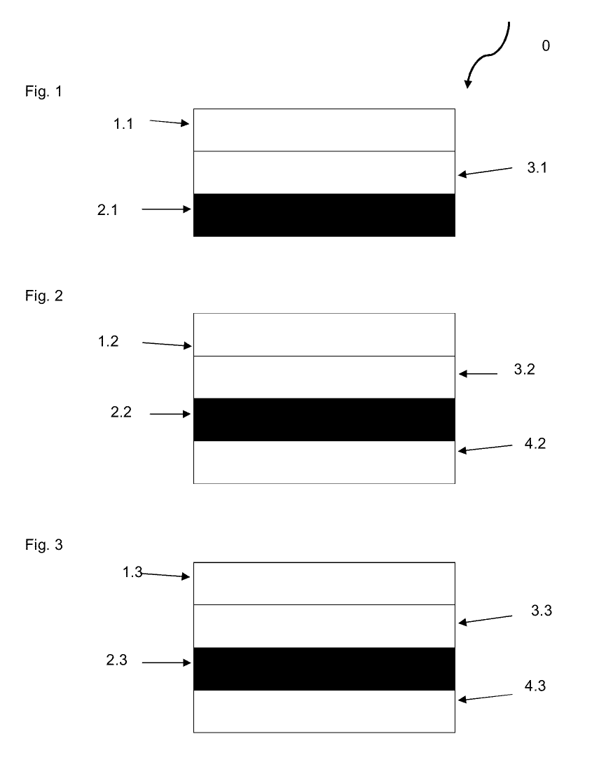

FIG. 1 shows a construction of an article of the invention, preferably of a label, having an outwardly exposed engraving layer 1.1, preferably comprising an acrylate varnish or a metal layer; the PSA K of the invention in the form of an adhesive layer 2.1; and a contrast layer 3.1 disposed between the engraving layer 1.1 and adhesive layer 2.1.

FIG. 2 shows a construction of an article of the invention, preferably of a label of that kind, having an outwardly exposed engraving layer 1.2, preferably comprising an acrylate varnish or a metal layer; an adhesive layer 2.2 comprising the PSA K of the invention, comprising as monomer a1 at least one acrylic acid and/or methacrylic acid with a fraction of greater than or equal to 3 wt % to less than or equal to 8 wt %, based on the fraction of component A1; a contrast layer 3.2 disposed between the engraving layer 1.2 and adhesive layer 2.2, comprising an electron beam-curable varnish; and a protective layer 4.2 disposed on the adhesive layer 2.2.

FIG. 3 shows a construction of an article of the invention, preferably of a label of that kind, having an outwardly exposed engraving layer 1.3, preferably comprising an acrylate varnish or a metal layer; an adhesive layer 2.3 comprising the PSA K of the invention, comprising as monomer a1 at least one acrylic acid with a fraction of greater than or equal to 3 wt % to less than or equal to 8 wt %, based on the fraction of component A1; a contrast layer 3.3 disposed between the engraving layer 1.3 and adhesive layer 2.3, comprising an electron beam-curable varnish; and a protective layer 4.3 disposed on the adhesive layer 2.3.

FIG. 4 shows a construction of an article of the invention, preferably of a label of that kind, having an outwardly exposed engraving layer 1.4, preferably comprising an acrylate varnish or a metal layer; an adhesive layer 2.4 comprising the PSA K of the invention, comprising as monomer a1 at least one acrylic acid with a fraction of greater than or equal to 3 wt % to less than or equal to 5 wt %, based on the fraction of component A1; a contrast layer 3.4 disposed between the engraving layer 1.4 and adhesive layer 2.4, comprising an electron beam-curable varnish; and a protective layer 4.4 disposed on the adhesive layer 2.4.

### WORKING EXAMPLES

The measurements are carried out (unless otherwise indicated) under test conditions of 23±1° C. and 50±5% relative humidity.

Measurement Methods/Information on Parameter Values Stated

Determination of the Average Molecular Weight of the Non-Crosslinked polyacrylate (Polymerization Product)

The information on the weight-average molecular weight M_{w}, on the number-average molar mass Mₙ and on the polydispersity P_{D} in this specification relates to the determination by gel permeation chromatography (GPC). The determination takes place on 100 μl of sample subjected to clarifying filtration (sample concentration 4 g/I). The eluent used is tetrahydrofuran with 0.1 vol % trifluoroacetic acid. The measurement takes place at 25° C.

The pre-column used is a PSS-SDV column, 5 μm, 10³ Å, 8.0 mm×50 mm (data here and below in the following order: type, particle size, porosity, internal diameter×length, 1 Å=10⁻¹⁰ m). Separation takes place using a combination of the PSS-SDV columns, 5 μm, 10³ Å and also 10⁵ Å and 10⁶ Å each with 8.0 mm×300 mm (columns from Polymer Standards Service; detection using Shodex R171 differential refractometer). The flow rate is 1.0 ml per minute. Calibration takes place against PMMA standards (polymethyl methacrylate calibration).

Softening Point Tₛ

The softening point Tₛ of resins is determined by the ring & ball method, by corresponding application of the provisions of DIN EN 1427:2007 (analysis of the resin sample instead of bitumen, with procedure otherwise retained). The measurements take place in a glycerol bath. The information on the softening point relates to the results of this measurement.

Glass Transition Temperatures T_{g}

Resin glass transition temperatures T_{g} were determined by dynamic mechanical analysis (DMA); the procedures selected were as follows: glass transition temperatures were determined by temperature sweep. All data in the context of this specification relate to the results of these measurements, unless specifically indicated otherwise. With DMA, use is made of the fact that the properties of viscoelastic materials under a sinusoidal mechanical stress are dependent on the frequency of the stress (i.e. the time) and also on the temperature.

All DMA Procedures:

Instrument: Rheometric Scientific RDA III; measuring head, spring-mounted with standard force; heating: heating chamber; measuring geometry: parallel plate arrangement, sample thickness 1 (±0.1) mm; sample diameter 25 mm (to produce a sample 1 mm thick, 5 layers (each 200 μm) of the adhesive tape under investigation were laminated to one another; since the PET carrier makes no significant contribution to the rheological properties, its presence can be disregarded).

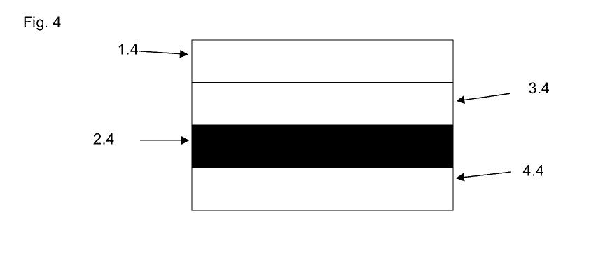

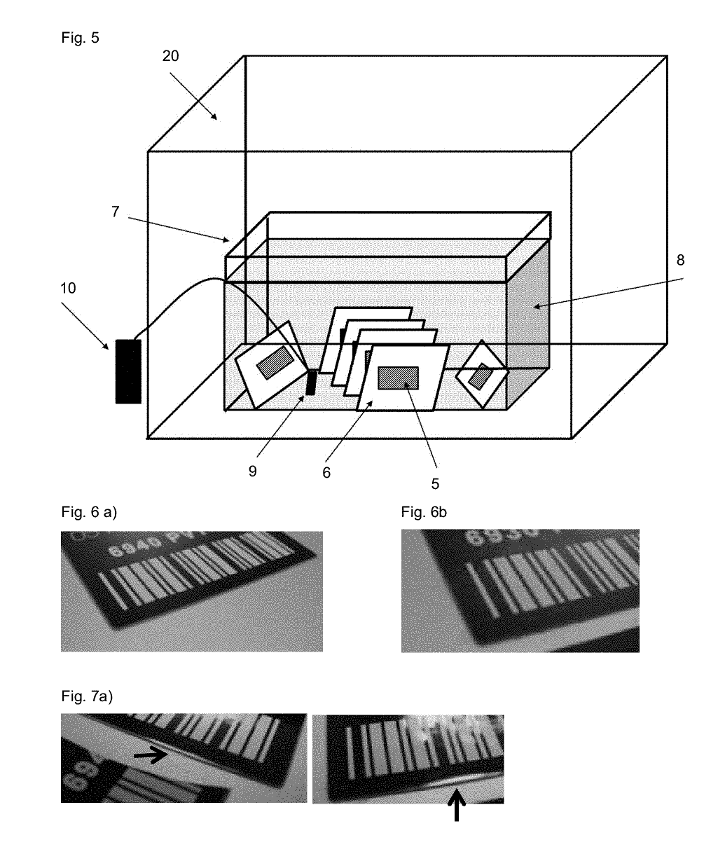

Water Stress Test (See FIG. 5)

The water stress test, or the resistance of the test adhesive tapes to water, was carried out in a heatable oven 20 at a temperature of 40° C. and at an elevated temperature of 60° C. (see FIG. 5). Located in the interior of the oven is a sample holder 7 which can be covered with a lid (not shown) and which is filled with distilled water 8. The water volume is selected such that throughout the duration of the test, the test adhesive tapes 5 are completely covered by distilled water. The sample holder is covered for the duration of the test, in order to minimize evaporation of the water.

Verification and control of the temperature of 40° C. and 60° C. takes place using a temperature sensor 9 with thermometer 10, the sensor being immersed in the water. The temperature can be read off outside the oven.

The test adhesive tapes 5 were adhered to ASTM steel test surfaces 6. Application of the test adhesive tapes 5 to the test surfaces 6 was followed by wetting of the substrate with the adhesive for a bonding time of 1 h, 24 h and 72 h, with h standing for hours. Thereafter the test surfaces were placed on end, slightly inclined, into the water 8-filled sample container 7, and were covered completely by water 8. The test surfaces 6 with the bonded test adhesive tapes 5 can be set up in an apparatus intended for that purpose (not shown), in order to prevent the test surfaces 6 tipping over and making contact with one another.

The test took place (FIG. 5) for a time of 500 h or 1000 h, in each case at 40° C. and at 60° C. This was followed by optical or visual assessment and evaluation in accordance with the following classification:

−−=complete detachment, greater than 50% of the surface
−=severe edge lifting, greater than 10% of the surface
0=slight edge lifting, reversible
+=individual blisters, reversible, removable by applying pressure
++=no change in the material

Evaluation took place after the test surfaces had been removed from the setup described (FIG. 5) and after a reconditioning time of 20 minutes at room temperature for the test adhesive tapes shown in FIG. 6 to FIG. 8.

High-Temperature Water Stress Test

The bonding time of the test adhesive tapes on the substrate (ASTM steel plates) was 1 h, 24 h and 72 h. Thereafter the test adhesive tapes were stored at water temperatures of 80° C., 90° C. and 100° C. for 15 minutes, with the test adhesive tapes fully covered with water. Evaluation took place according to the same classification as described above, immediately after removal from the water and after a reconditioning time of 24 h. The results are set out in Table 4.

Determination of the Cohesion/Flexibility Using the Micro-Shear Adhesion Test:

This test is a rapid test for assessing the cohesion or flexibility of an adhesive, more particularly of a pressure sensitive adhesive, and is reported in μm. The higher the value [μm], the more flexible the adhesive, more particularly the PSA.

A strip of the adhesive tape 1 cm wide is adhered to a polished steel plaque (test substrate) over a length of 5 cm, by passing a 2 kg roller over the adhered strip ten times. The test strip is reinforced with a PET film 190 μm thick and then cut off with a straight edge using a fixing apparatus. The edge of the reinforced test strip projects 1 mm over the edge of the steel plaque. The plaques are equilibrated under test conditions (23° C., 50% relative humidity) for 15 minutes, in the measuring apparatus but without loading. Thereafter the desired test weight (in this case, 50 g) is hung on, so producing a shearing stress parallel to the bond area. A travel sensor with a resolution in the μm range is used to plot the shearing travel as a function of time, in the form of a graph.

Reported as microshear travel μS1 is the shear travel (shearing distance) after weight loading for a defined time (in this case: 10 minutes).

Determination of the Adhesive Force from the Peel Strength to ISO 29862:2007

The adhesive force of an adhesive, more particularly of a PSA, was determined as peel strength with a peel rate of 300 mm/min, exerted at an angle of 180° to the bonded test adhesive tape on the steel substrate.

For the measurement of the bond strengths, test strips 19 mm wide were adhered without bubbles to a finely abraded (emery paper with FEPA 240 grade) steel plate made of stainless steel, and were pressed on using a rubber-clad 2 kg roller, with a speed of 10 m/min. The steel plate and the protruding end of the adhesive tape were then clamped into the ends of a tensile testing machine in such a way as to produce a peel angle of 180°. The adhesive tape was peeled from the steel plate with a speed of 300 mm/min. The bond strength is reported in N/cm.

The adhesive force in N/cm of the various test adhesive tapes was determined on ASTM steel plates

a) temperature-dependently (Table 2a) at 23° C., 40° C., 70° C. and 100° C. after a bonding time of 72 h, and
b) in dependence on the bonding time (Table 2b) of 0 minutes (determination directly after application of the test adhesive tape to the substrate), 20 minutes, 1 h, 24 h and 72 h at room temperature. The N/cm values determined according to b) were additionally expressed in %, with the value of the 72 h being defined as 100% (Table 2c).

Determination of the Water Absorption of the Laser Films

The water absorption was determined by means of coulometric Karl-Fischer titration. The samples were stored at 50° C. water temperature for 72 h, during which the samples were fully covered by the water. The water absorption was measured after removal of the samples from the water and after a reconditioning time of 1 h or 24 h. The results are reported in % (Table 3).

### Example 1: Composition of Inventive PSAs

Test adhesive tapes of the compositions as shown in Table 1 were produced and were tested in the water stress test. The results of the water stress test are shown in Table 1.

TABLE 1a
Composition of PSAs

| | Com- | | | Reference | Reference | Adhesive | Adhesive | Adhesive |
|---|---|---|---|---|---|---|---|---|
| | ponent | | Unit | I | II | I | II | III |
| Acrylic acid | a1 | A1 | wt % | 1 | 1 | 3 | 5 | 3 |
| Butyl acrylate | b | | wt % | 48.5 | 49.5 | 43.5 | 47.5 | 48.5 |
| Ethylhexyl | b | | wt % | 48.5 | 49.5 | 43.5 | 47.5 | 48.5 |
| acrylate | | | | | | | | |
| Glycidyl | b | | wt % | 2 | − | − | − | − |
| methacrylate | | | | | | | | |
| Methyl | b | | wt % | − | − | 10 | − | − |
| acrylate | | | | | | | | |

| | | | | | | | |
|---|---|---|---|---|---|---|---|
| Resin | A2 | wt % | 20-40 | 20-40 | 20-40 | 20-40 | 20-40 |
| (terpene- | | on poly | | | | | |
| phenolic) | | solid | | | | | |
| Crosslinker I | B | Parts by | − | 0.025- | 0.025- | 0.025- | 0.025- |
| (Erisys GA 240) | | weight | | 0.075 | 0.075 | 0.075 | 0.075 |
| | | on poly | | | | | |
| | | solid | | | | | |
| Crosslinker II | B | Parts by | − | or | or | or | or |
| (Al chelate) | | weight | | 0.1-0.2 | 0.1-0.2 | 0.1-0.2 | 0.1-0.2 |
| | | on poly | | | | | |
| | | solid | | | | | |
| Crosslinker III | B | Parts by | 0.3 ZnCl + | − | − | − | − |
| | | weight | 0.15 Desm. | | | | |
| | | on poly | L75 | | | | |
| | | solid | | | | | |
| Water | — | Visual | o | o | ++ | ++ | ++ |
| resistance | | eval- | | | | | |
| 1000 h at | | uation | | | | | |
| 40° C. | | | | | | | |
| Water | — | Visual | −− | −− | o | ++ | o |
| resistance | | eval- | | | | | |
| 1000 h at | | uation | | | | | |
| 60° C. | | | | | | | |

−− = complete detachment, greater than 50% of the surface;
− = severe edge lifting, greater than 10% of the surface;
o = slight edge lifting, reversible;
+ = individual blisters, reversible, removable by applying pressure;
++ = no change in the material

### Example 2: Adhesives Investigated, Especially PSAs

The following adhesives were tested in different test adhesive tapes:

Adhesive A (Reference 1):

Adhesive of product tesa 6940 PV1—HHR (Comparative adhesive)

Adhesive A is an acrylic PSA modified with a resin and UV pigments. Cohesion/flexibility: 45.1 μm

Adhesive B (Reference II):

Adhesive of 6930 PV6 AF48 (Comparative adhesive) Adhesive B is an acrylic PSA modified with a plasticizer and UV pigments and therefore more flexible than adhesives A and C. Cohesion/flexibility: 117.6 μm

Adhesive C (Adhesive 1):

Alternative I—slight deviation from adhesive A Adhesive C is an acrylic PSA which is modified with a resin and UV pigments and has a higher polarity than adhesives A and B. Its adhesive force corresponds to the adhesive force of adhesive A. Cohesion/flexibility: 60.0 μm

Adhesive D (Adhesive 2):

Alternative II—great deviation from adhesive A Adhesive D is an acrylic PSA which is modified with a resin and UV pigments and is more flexible than adhesives A, B and C. Its adhesive force is higher than that of adhesive A. Cohesion/flexibility: 206.1 μm

Adhesive E (Adhesive 3):

Alternative III—slight deviation from adhesive A Adhesive E is an acrylic PSA which is modified with a resin and UV pigments and has a higher polarity than adhesives A, B, C and D. Its adhesive force is higher than the adhesive force of adhesive A.

### Example 3: Adhesive Force of the Adhesives, Especially of the PSAs

TABLE 2a
Temperature-dependent adhesive force

| | Reference I | Reference II | Adhesive I | Adhesive III |
|---|---|---|---|---|
| Temperature | [N/cm] | [N/cm] | [N/cm] | [N/cm] |
| 23° C. | 6.43 | 5.14 | 5.96 | 9.89 |
| 40° C. | 5.61 | 5.87 | 5.40 | 8.65 |
| 70° C. | 4.15 | 3.93 | 4.38 | 7.29 |
| 100° C. | 3.67 | 3.07 | 3.27 | 5.89 |

The temperature-dependent determination of the adhesive force shows a decrease in the adhesive force for increasing temperature.

TABLE 2b
Bonding time-dependent adhesive force in N/cm

| Bonding | Reference | Reference | Adhesive | Adhesive | Adhesive |
|---|---|---|---|---|---|
| time | I [N/cm] | II [N/cm] | I [N/cm] | III [N/cm] | II [N/cm] |
| 0 | 4.57 | 2.72 | 4.53 | 6.07 | 6.6 |
| 20 minutes | 4.97 | 3.78 | 5.20 | 7.37 | 8.2 |
| 60 minutes | 5.13 | 3.83 | 5.22 | 7.9 | 8.7 |
| 24 hours | 6.02 | 4.91 | 5.64 | 9.12 | 9.4 |
| 72 hours | 6.43 | 5.14 | 5.96 | 9.42 | 10.8 |

TABLE 2c
Bonding time-dependent adhesive force in %

| Bonding | Reference | Reference | Adhesive | Adhesive | Adhesive |
|---|---|---|---|---|---|
| time | I [%] | II [%] | I [%] | III [%] | II [%] |
| 0 | 71 | 53 | 76 | 64 | 70 |
| 20 minutes | 77 | 74 | 87 | 78 | 76 |
| 60 minutes | 80 | 75 | 88 | — | 80 |
| 24 hours | 94 | 96 | 95 | 97 | 87 |
| 72 hours | 100 | 100 | 100 | 100 | 100 |

With increasing bonding time there is an increase in the adhesive force of the adhesives, especially of the PSA, to the substrate (Table 2b). Starting from the complete wetting (100%) after 72 h of the substrate with the respective PSA, after a relatively short bonding time of 24 h, the wetting of the substrate with the adhesive, more particularly the adhesion of adhesive A, B, C, D or E to the substrate, at 95% to 97%, is not finished. In the regions of the adhesive tape with incomplete wetting of the surface by the PSA, there is a risk of blistering or swelling of the adhesive tapes in the water stress test. At 9.42 N/cm, adhesive III has the highest adhesive force after a bonding time of 72 h, this being attributable to the increased cohesion/flexibility of adhesive III. After a bonding time of 72 h, adhesive III has an adhesive force which is higher by around 31% than that of the reference adhesive I (6.43 N/cm) and higher by about 45% than adhesive B (5.14 N/cm).

### Example 4: Water Absorption of the Laser Films

TABLE 3
Water absorption

| | | 72 h | 72 h |
|---|---|---|---|
| | Untreated | 50° C./1 h | 50° C./24 h |
| | [%] | [%] | [%] |
| Laser film with reference adhesive | 0.75 | 1.44 | 0.99 |
| Laser film with adhesive III | 0.88 | 1.56 | 1.22 |

In comparison to the untreated laser films 6930 PV6 and 6940 PV1, which have a water content of 0.75% and 0.88%, an increase in the water content is detectable after storage for 72 h in water. Depending on the reconditioning time of 1 h and 24 h, the water escapes from the swollen laser film, as detectable from the measurable decrease in water content in the PSA, from 1.44% to 0.99% and from 1.56% to 1.22%.

### Example 5: High-Temperature Water Stress Test

TABLE 4
Water resistance

| Water | Bonding time | Reference | Reference | Adhesive | Adhesive | Adhesive |
|---|---|---|---|---|---|---|
| temperature | [h] | I | II | I | II | III |
| 80° C. | 1 | 0 | − | 0 | ++ | ++ |
| | 24 | 0/+ | 0 | + | ++ | ++ |
| | 72 | ++ | 0 | ++ | ++ | ++ |
| 90° C. | 1 | − | 0 | 0 | ++ | ++ |
| | 24 | −/0 | 0 | ++ | ++ | ++ |
| | 72 | − | − | ++ | ++ | ++ |
| 100° C. | 1 | − | − | ++ | ++ | ++ |
| | 24 | − | − | + | ++ | ++ |
| | 72 | − | 0 | ++ | ++ | ++ |

−− = complete detachment, greater than 50% of the surface;
− = severe edge lifting, greater than 10% of the surface;
0 = slight edge lifting, reversible;
+ = individual blisters, reversible, removable by applying pressure;
++ = no change in the material

Adhesive III displays a water resistance which is consistently good at all temperatures, irrespective of the bonding time or wetting time. In contrast, the water resistance of adhesive I decreases with shorter bonding time and increasing temperature. Adhesive B displays the lowest water resistance at a temperature of 100° C. with a bonding time of 1 h. Adhesive A consistently has a low to poor water resistance, and particularly low at 90° C. and 100° C.

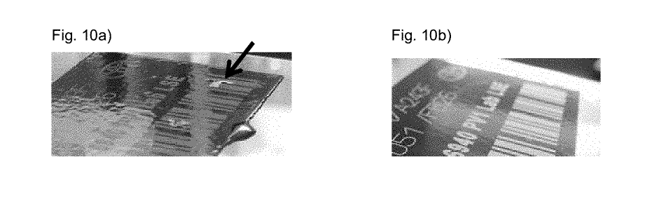

The effect of the reconditioning time is shown in FIG. 9 and FIG. 10. After a bonding time of 1 h and after subsequent exposure to a water temperature of 100° C. for the test adhesive tape bonded with the reference adhesive I, this tape exhibits significant edge lifting directly after removal from the water (FIG. 9a)). After a reconditioning time of 24 h, the adhesive tape regains a state in which it adheres over the full area (FIG. 9b)).

In contrast to the reference adhesive, the test adhesive tape bonded with the adhesive III exhibits blistering after a bonding time of 1 h and subsequent exposure to a water temperature of 100° C., after direct removal from the water (FIG. 10a)). However, after a reconditioning time of 24 h, no blisters have remained, and the adhesive tape regains a blister-free adhering state (FIG. 10b)).

### Example 6: Results of the Water Stress Test

The above-described adhesives were tested in the water stress test described.

After 500 h at 40° C., the test surfaces in all cases, after a bonding time of 72 h, showed no alteration of the material and hence also no edge lifting or detachment from the substrate, as shown by way of example for adhesive A and B in FIGS. 6a) and 6b).

After 500 h at 60° C., the test adhesive tapes bonded with reference adhesive I for 72 h beforehand exhibited slight reversible edge lifting and slight blistering (FIG. 7a)). For adhesive B, after a bonding time of 72 h, severe edge lifting, blistering and detachment of the test surface from the substrate were observed (FIG. 7b)). For adhesives I, II and III, only slight reversible edge lifting or no change in the material was found. Consequently, adhesives I, II and III in the water stress test exhibit improved resistance towards water, relative to reference adhesive I and B.

After 1000 h at 40° C., the results achieved were similar to those as after 500 h at 40° C., with the test adhesive tapes bonded with reference adhesive I and B for 72 h already exhibiting slight blistering. Adhesives I, II and III showed no change in the material and therefore display an improved resistance towards water relative to reference adhesive I and B.

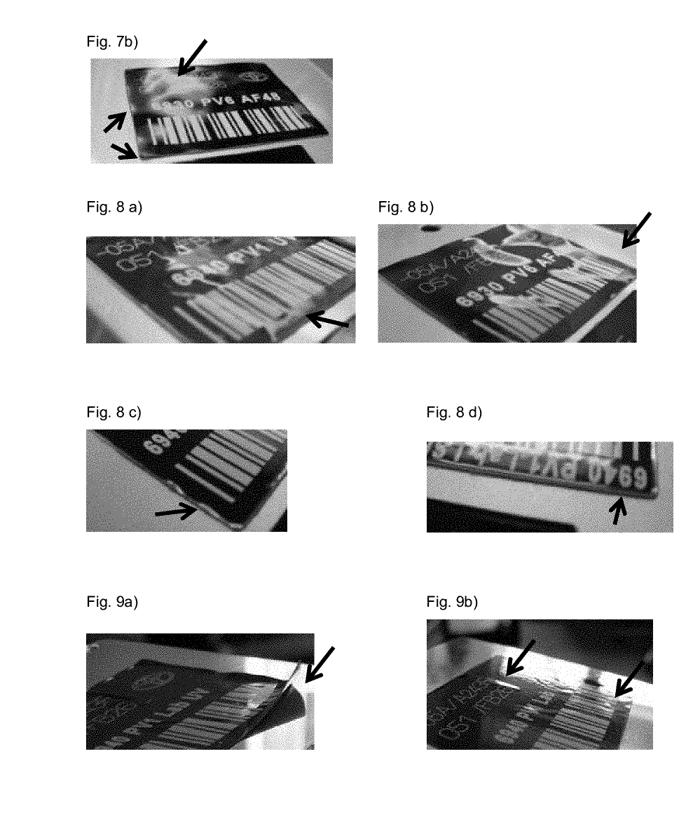

After 1000 h at 60° C., blistering and slight edge lifting are evident in the test adhesive tape bonded with the reference adhesive for 72 h (FIG. 8a)). Adhesive B does not pass the water stress test at 60° C. for 100 h, and exhibits severe edge lifting, blistering and detachment from the substrate (FIG. 8b)). Adhesives I and III show only slight edge lifting and therefore display an improved resistance towards water relative to reference adhesive I and B (FIG. 8c) and FIG. 8d)).

The tests with the above-described adhesives show that a sufficiently high adhesion of the adhesive, especially of the pressure sensitive adhesive (PSA), to the substrate and/or a sufficiently high flexibility of the adhesive is able to compensate the lengthwise and widthwise stretching force, especially on the film. Adhesives I, II and III exhibit enhanced resistance towards water, attributable to the increased polarity of the polymers and to the flexibility of the adhesive, especially of the PSA. All three adhesives I, II and III pass the water stress test at 40° C., and display improved properties at 60° C. relative to the reference adhesives A and B.

1. Use of the pressure sensitive adhesive (PSA) K for bonding to high polarity surfaces, the PSA K being the product of crosslinking of a polymer material comprising at least the following components:
(A) at least one polymer component A comprising:
(i) greater than or equal to 60 wt % to less than or equal to 80 wt %, based on the amount of polymer component A, of at least one component A1, component A1 comprising:
(i-a) greater than or equal to 1 wt % to less than or equal to 15 wt %, based on the total amount of component A1, of at least one monomer a comprising compounds having at least one ethylenically unsaturated bond, and selected in each case such that the glass transition temperature T_{g} of the corresponding homopolymer of the respective monomer a is at least 0° C., at least part of the total fraction of monomer a being present as at least one monomer a1 comprising compounds having at least one ethylenically unsaturated bond and at least one carboxylic acid group, and
(i-b) greater than or equal to 85 wt % to less than or equal to 99 wt %, based on the total amount of component A1, of at least one monomer b selected from the group of acrylic esters and/or methacrylic esters, selected in each case such that the glass transition temperature T_{g} of the corresponding homopolymer of the respective monomer b is less than or equal to −30° C.,
the (i-a) at least one monomer a and the (i-b) at least one monomer b being present in total with a fraction of 100 wt % in component A1,
(ii) greater than or equal to 20 wt % to less than or equal to 40 wt %, based on the amount of polymer component A, of at least one resin component A2,
the (i) at least one component A1 and the (ii) at least one resin component A2 being present in total with a fraction of 100 wt % in polymer component A, and
(B) at least one crosslinker component B comprising covalently crosslinking di- or polyfunctional compounds,
the (A) at least one polymer component A and the (B) at least one crosslinker component B being present in total with a fraction of greater than or equal to 95 wt % in the overall composition of the polymer material, and
the high polarity surfaces comprising
(I) at least one hydroxyl, carbonyl, carboxyl, SH or NH group and/or at least one ionic group, and/or
(II) at least one adsorbed migratable compound containing at least one hydroxyl group.

2. Use of the PSA K according to claim 1, characterized in that the (i-a) at least one monomer a is selected from
(a1) a monomer a1 comprising ethylenically unsaturated compounds having a T_{g} of greater than or equal to 0° C. and at least one carboxylic acid group,
(a2) a monomer a2 comprising ethylenically unsaturated compounds having a T_{g} of greater than or equal to 0° C. and at least one ester group, and/or
(a3) a monomer a3 comprising ethylenically unsaturated compounds having a T_{g} of greater than or equal to 0° C. and comprising neither carboxyl groups (—COOH) nor ester groups with an ethyl and/or methyl radical,
the fraction of the monomer a being greater than or equal to 1 wt % to less than or equal to 15 wt %, based on the total amount of component A1, and the fraction of the monomer a1 therein being greater than or equal to 1 wt % to less than or equal to 8 wt %, based on the total amount of component A1.

3. Use of the PSA K according to either of claims 1 and 2, characterized in that the at least one monomer a1 is selected from the group of carboxylic acids comprising acrylic acid, methacrylic acid and/or mixtures of the two.

4. Use of the PSA K according to any of claims 1 to 3, characterized in that the at least one monomer b is selected from the group comprising acrylic esters having linear, branched and/or functional-group-substituted alkyl radicals, the linear alkyl radical having greater than or equal to 3 carbon atoms to less than or equal to 14 carbon atoms.

5. Use of the PSA K according to any of claims 1 to 4, characterized in that the at least one monomer b is selected from
a) unsubstituted linear acrylic esters comprising methyl acrylate, butyl acrylate, propyl acrylate, n-pentyl acrylate, n-hexyl acrylate, n-heptyl acrylate, n-octyl acrylate, n-nonyl acrylate, n-decyl acrylate, n-undecyl acrylate, n-dodecyl acrylate, n-tridecyl acrylate, n-tetradecyl acrylate and/or
b) branched unsubstituted and/or substituted acrylic esters comprising 2-heptyl acrylate, 2-octyl acrylate, ethylhexyl acrylate, 2-ethoxyethyl acrylate, 2-ethylhexyl acrylate, 2-ethylbutyl acrylate, 3-methoxybutyl acrylate, 2-methoxyethyl acrylate, 3-methoxypropyl acrylate, 3-methylbutyl acrylate and isodecyl acrylate
with an amount of greater than or equal to 87 wt % to less than or equal to 100 wt %, based on the total amount of component A1.

6. Use of the PSA K according to any of claims 1 to 5, characterized in that the high polarity surfaces comprise
(I) surfaces of mineral building materials, surfaces comprising at least one urea, amide and/or isocyanate group and/or
(II) wet surfaces and/or moist surfaces, in each case independently comprising at least one adsorbed migratable compound comprising at least one hydroxyl group and selected from H₂O, H₂O in condensed phase, H₂O in vapour, steam, H₂O in aqueous solution, H₂O in crystalline form, H₂O in moisture, H₂O in a mixture comprising oil, H₂O in an emulsion, H₂O in a dispersion and H₂O in smoke, from at least one alcohol, or from an aqueous-alcoholic solution, compound comprising at least one hydroxyl group in mixtures with esters, and/or mixtures of at least two of the aforementioned components.

7. Use of the PSA K according to any of claims 1 to 6, characterized in that the at least one carboxylic acid group of component A1 in the polymer material, with the polar surfaces and/or with the migratable compounds adsorbed on the polar surfaces, forms supramolecular structures based on a network of hydrogen bonds.

8. Use of the PSA K according to any of claims 1 to 7, characterized in that the PSA K is in the form of at least one layer.

9. Use of the PSA K according to any of claims 1 to 8, characterized in that the layer of PSA is in the form of a sheetlike bonding means in a laser-writable multilayer article comprising films, diecuts and labels, the article comprising at least the following layers:
(1) at least one engraving layer,
(2) at least one contrast layer, disposed below the engraving layer, and
(3) at least one adhesive layer comprising the PSA K, disposed below the contrast layer.

10. Use of the PSA K according to claim 9, characterized in that additionally in the laser-writable multilayer article
(1.1) a support film is disposed on the (1) engraving layer,
(1) the engraving layer comprises a radiation-curable varnish,
(2) the contrast layer comprises an electron beam-curable varnish, the engraving layer and contrast layer contrasting very greatly with one another,
(3) the adhesive layer has a thickness of greater than or equal to 7 μm to less than or equal to 70 μm, and
(4) optionally a protective layer is applied on the adhesive layer.

11. Use according to any of claims 8 to 10, characterized in that in the water stress test, the sheetlike bonding means exhibits a water resistance of 40° C. of greater than or equal to 100 h to less than or equal to 1000 h.

12. Use according to any of claims 8 to 11, characterized in that in the water stress test at 40° C., the sheetlike bonding means exhibits no more than reversible blistering after greater than or equal to 100 h to less than or equal to 1000 h.

13. Water-resistant, laser-writable multilayer article comprising at least the following layers:
(1) at least one engraving layer,
(2) at least one contrast layer, disposed below the engraving layer, and
(3) at least one adhesive layer comprising the PSA K, disposed below the contrast layer,
the PSA K being the product of crosslinking of a polymer material comprising at least the following components:
(A) at least one polymer component A comprising:
(i) greater than or equal to 60 wt % to less than or equal to 80 wt %, based on the amount of polymer component A, of at least one component A1, component A1 comprising:
(i-a) greater than or equal to 2.5 wt % to less than or equal to 15 wt %, based on the total amount of component A1, of at least one monomer a comprising compounds having at least one ethylenically unsaturated bond, and selected in each case such that the glass transition temperature Tg of the corresponding homopolymer of the respective monomer a is at least 0° C.,
at least part of the total fraction of monomer a being present as at least one monomer a1 comprising compounds having at least one ethylenically unsaturated bond and at least one carboxylic acid group, and
(i-b) greater than or equal to 85 wt % to less than or equal to 97.5 wt %, based on the total amount of component A1, of at least one monomer b selected from the group of acrylic esters and/or methacrylic esters, selected in each case such that the glass transition temperature Tg of the corresponding homopolymer of the respective monomer b is less than or equal to −30° C.,
the (i-a) at least one monomer a and the (i-b) at least one monomer b being present in total with a fraction of 100 wt % in component A1,
(ii) greater than or equal to 20 wt % to less than or equal to 40 wt %, based on the amount of polymer component A, of at least one resin component A2,
the (i) at least one component A1 and the (ii) at least one resin component A2 being present in total with a fraction of 100 wt % in polymer component A, and
(B) at least one crosslinker component B comprising covalently crosslinking di- or polyfunctional compounds,
the (A) at least one polymer component A and the (B) at least one crosslinker component B being present in total with a fraction of greater than or equal to 95 wt % in the overall composition of the polymer material.

14. Article according to claim 13, characterized in that the adhesive layer of the PSA K comprising the monomer a1 is selected from acrylic acid and/or methacrylic acid with a fraction of greater than or equal to 2.5 wt % to less than or equal to 15 wt %, based on the total amount of component A1, preferably greater than or equal to 2.5 wt % to less than or equal to 8 wt %.

15. Article according to either of claims 13 and 14, characterized in that the contrast layer is based on a cured acrylate varnish composition comprising
(a) greater than or equal to 30 wt % to less than or equal to 80 wt % of a trifunctional oligomer A
(b) greater than or equal to 0 wt % to less than or equal to 20 wt % of a trifunctional monomer B
(c) greater than or equal to 1 wt % to less than or equal to 30 wt % of a difunctional monomer C and
(d) greater than or equal to 2 wt % to less than or equal to 40 wt % of a colouring pigment.

16. Article according to any of claims 13 to 15, characterized in that in the high-temperature water stress test at 100° C. it is water-resistant for 15 minutes.

17. Article according to any of claims 13 to 16, characterized in that it has an adhesive force, measured as peel strength to ISO 29862, of greater than or equal to 5 N/cm at 23° C.

18. Article according to any of claims 13 to 17, characterized in that it is in the form of a label, film and/or diecut.

19. Use of the water-resistant, laser-writable and multilayer article according to any of claims 13 to 18, characterized in that in the water stress test at 40° C., it is water-resistant for greater than or equal to 100 h.

20. Use of the article according to any of claims 13 to 18, characterized in that in the water stress test at 40° C., it exhibits no more than reversible blistering for greater than or equal to 100 h.

21. Method for producing a multilayer article according to any of claims 13 to 18, comprising the following steps:
1) providing a support film,
2) applying an engraving layer to the support film,
3) applying a composition for producing a contrast layer to the engraving layer,
4) curing the composition from step 3), to give a contrast layer,
5) applying a PSA K to the contrast layer and covering the PSA K with a protective paper or release liner, the PSA K being the product of crosslinking of a polymer material comprising at least the following components:
(A) at least one polymer component A, comprising:
(i) greater than or equal to 60 wt % to less than or equal to 80 wt %, based on the amount of polymer component A, of at least one component A1, component A1 comprising:
(i-a) greater than or equal to 3 wt % to less than or equal to 15 wt %, based on the total amount of component A1, of at least one monomer a comprising compounds having at least one ethylenically unsaturated bond, and selected in each case such that the glass transition temperature Tg of the corresponding homopolymer of the respective monomer a is at least 0° C.,
at least part of the total fraction of monomer a being present as at least one monomer a1 comprising compounds having at least one ethylenically unsaturated bond and at least one carboxylic acid group, and
(i-b) greater than or equal to 85 wt % to less than or equal to 97 wt %, based on the total amount of component A1, of at least one monomer b selected from the group of acrylic esters and/or methacrylic esters, selected in each case such that the glass transition temperature Tg of the corresponding homopolymer of the respective monomer b is less than or equal to −30° C.,
the (i-a) at least one monomer a and the (i-b) at least one monomer b being present in total with a fraction of 100 wt % in component A1,
(ii) greater than or equal to 20 wt % to less than or equal to 40 wt %, based on the amount of polymer component A, of at least one resin component A2,
the (i) at least one component A1 and the (ii) at least one resin component A2 being present in total with a fraction of 100 wt % in polymer component A, and
(B) at least one crosslinker component B comprising covalently crosslinking di- or polyfunctional compounds,
the (A) at least one polymer component A and the (B) at least one crosslinker component B being present in total with a fraction of greater than or equal to 95 wt % in the overall composition of the polymer material,
6) and removing the support film.

22. Method for producing a multilayer article according to claim 21, characterized in that in step 3) a composition is applied comprising
(a) greater than or equal to 30 wt % to less than or equal to 80 wt % of a trifunctional oligomer A
(b) greater than or equal to 0 wt % to less than or equal to 20 wt % of a trifunctional monomer B
(c) greater than or equal to 1 wt % to less than or equal to 30 wt % of a difunctional monomer C and
(d) greater than or equal to 2 wt % to less than or equal to 40 wt % of a colouring pigment.
